(19) United States
(12) Patent Application Publication
(10) Pub. No.: US 2013/0319945 A1
(43) Pub. Date: Dec. 5, 2013

(54) Device and Method for Field Flow Fractionation

(71) Applicants: Ulrich Rosch, Urbach (DE); Christoph Johann, Woldert (DE)

(72) Inventors: Ulrich Rosch, Urbach (DE); Christoph Johann, Woldert (DE)

(73) Assignee: WYATT TECHNOLOGY EUROPE GMBH, Dernbach (DE)

(21) Appl. No.: 13/825,632

(22) PCT Filed: Sep. 22, 2011
(86) PCT No.: PCT/EP2011/066548

§ 371 Date: Aug. 16, 2013

(30) Foreign Application Priority Data
Sep. 22, 2010 (DE) 10 2010 041 222.8

(51) Int. Cl. G01N 30/00

(52) U.S. Cl. CPC G01N 30/0005
USPC 210/659; 210/137; 210/739

(57) ABSTRACT

A device for field flux fractioning comprises a sensor to determine the presence of particles in a liquid and a channel impermeable for particles and permeable for liquid. A pump conveys the liquid to first and second paths to the channel, where the second path connects in a first position to the pump outlet and in a second position to the sensor. An injection device injects a sample comprising particles into the liquid flowing through the first path. A distribution device distributes the flow volume conveyed by the pump in a first position at a predetermined ratio to the first and second paths. A control device comprises a valve and a measuring device to measure the flow volume. The valve controls the flow volume in the first path in consideration of the measuring device measurement and the pump conveys the liquid in a flow volume, which can be precisely dosed.

The invention relates to a device and a method for field flux fractioning.

Field flux fractioning (FFF) relates to a separating method for a given sample system, which usually comprises at least one or two sample components to be analyzed in a carrier liquid. The sample components to be analyzed comprise particulates, which particularly represent particles, macro-molecules, or molecules. Concretely, “field flux fractioning” is understood as analyzing techniques, with their separating mechanism operating such that different particles collect at different elevations under the influence of a lateral force acting essentially perpendicular in reference to the direction of the flow. For this purpose essentially a parabolic-shaped flow profile is used for the carrier liquid, generated in a usually oblong, thin channel, also called the separating channel. The separation of the different particles from each other occurs in this channel, from which then the different particles are eluted at different times.

The channel forms an essentially closed, thin, oblong hollow body, usually a tube or the like, which comprises a first end with a first connection and a second end with a second connection and its wall comprises at least one section, extending in the longitudinal direction of the channel, impermeable for the particles and permeable for the carrier liquid. A portion of the carrier liquid is deviated via this permeable section. Preferably the permeable section in the wall of the channel comprises an ultra-filtration membrane.

In order to generate the above-mentioned lateral force, which ensures the deviation of some of the carrier liquid out of the channel through the permeable section in the wall of said channel, in one variant of the field flux fractioning a lateral flow is generated from the outside in the channel perpendicular and/or at a right angle in reference to the direction of flow of the carrier liquid and thus the longitudinal extension of the channel. For this purpose, additional liquid, preferably carrier liquid is pumped via an inlet into the channel which is additionally embodied in the wall of the channel and is essentially precisely located opposite the permeable section and thus symmetrical in reference thereto. Accordingly, this variant of the method is called symmetric field flux fractioning.

However, it has been found that the introduction of additional carrier liquid in the perpendicular direction can also be waived without here any noticeable worsening of the measuring results has to be accepted. This variant of the method is called the asymmetrical field flux fractioning (AFFFF and/or AF4). In this method the reduced pressure developing at the permeable section is used for separating a portion of the carrier liquid as a lateral flux. Usually, when using this method only a single permeable section is embodied in the wall of the channel in the longitudinal direction. Alternatively, increasingly embodiments of a channel are used in which the wall is embodied permeable for the carrier liquid over its entire circumference; in general these embodiments relate to hollow fibers. Compared to symmetrical field flux fractioning, the asymmetric field flux fractioning yields separations of similar quality, however the channels for the asymmetrical field flux fractioning can be produced much easier and are much less cumbersome in their handling, for example during cleaning of the channel or when exchanging the membrane.

The carrier liquid is pumped through the channel, with for example the first connection being formed at the first end as the flow inlet and the second connection at the second end as the flow outlet. Preferably the channel shows a tapering progression extending in the direction of its longitudinal axis towards the flow outlet. The sample, as already mentioned representing particles, is inserted into the channel in a dissolved or suspended form, with here due to its low height (e.g., 300 μm) a laminar flow profile forms, with the flow rate in the channel being maximal in the center and approaching zero at its walls. The above-mentioned permeable section in the wall of the channel is preferably located at the bottom of the channel. From this permeable section a portion of the carrier liquid moves the bottom and this way generates a lateral flow, which in turn generates a defined force field essentially perpendicular in reference to the flow rate in the channel. By this separating force the sample components to be analyzed are pressed in the direction towards the permeable section. Due to the fact that this permeable section is embodied such that the carrier liquid is allowed to pass but the particles are not, these particles are consequently retained at the inside of said permeable section inside the channel. Due to the different sizes and thus the different diffusion coefficients smaller particles diffuse farther back in the channel than larger ones and thus reach faster flow sections of the parabolic carrier flow so that smaller particles accordingly leave the channel thus are eluted from the channel faster than larger particles. The retention periods for the different particles, i.e. the times required for the particles to be analyzed passing through the channel, are used as measurements for the identification and analysis of the particles.

When using field flux fractioning and particularly asymmetric field flux fractioning, substances can be separated within a range from preferably approx. 1 nm to 1000 nm. This method is the most universal chromatographic method for all nano-sized substances. Many separating problems can be solved with this method, when liquid chromatography—column technology had failed.

The advantages of field flux fractioning and particularly asymmetric field flux fractioning are particularly given in that expensive sample preparation can be omitted, a universal application is possible for different sample materials and sizes, no shearing forces and only negligible absorption effects develop, the separation conditions can be easily adjusted to the respective separation problems, and the separation occurs exclusively via the hydro-dynamic radius of the substance. Accordingly the method of field flux fractioning and particularly asymmetrical field flux fractioning is increasingly used to characterize macro-molecular substances in the fields of medicine, biology, biochemistry, pharmacy, polymer chemistry, agricultural sciences, etc., and in the most recent years it is also successful in a commercial sense.

The method of field flux fractioning is divided into four operating states. In the first operating state the so-called focusing occurs. Here, pure carrier liquid, not yet containing any samples, is pumped through the connections at both ends of the channel into said channel, causing two opposite flow fronts to form, which meet each other at a certain point in the channel. Here, the carrier liquid pumped into the channel through the two connections is dispensed from the channel through the permeable section in the wall of the channel. At the point where the two oppositely aligned flow fronts meet a so-called neutral zone develops, in which no flowing occurs in the longitudinal direction of the channel, however a lateral flow forms in the direction towards the permeable section in the wall of the channel, which is also called the accumulation wall. In the following this neutral zone is described in greater detail as the starting point for the sample. Accordingly it must be ensured that the sample is placed in this neutral zone of the channel. The location of the neutral zone is also called the relaxation point.

In the second operating state, in additional to the ongoing focusing, a sample is injected. For inserting the sample into the channel, in addition to the two above-mentioned connections, an injection port is provided as a third connection, which preferably is embodied in the wall of the channel opposite the permeable section. Due to the fact that the injection port at the wall of the channel is mounted fixed and thus located at a defined position the influx of the carrier liquid must be adjusted through the connections at both ends of the channel such that the above-mentioned neutral zone is positioned directly at the injection port. In order to allow controlling this fact the wall of the channel is embodied transparent at least in the area of the injection port. Prior to inserting a sample first a colorant is inserted via the injection port, which then essentially accumulates in the neutral zone and serves as a marker. This way the position of the neutral zone can be detected and controlled. If it is detected by monitoring the wall of the channel via the transparent section in the wall that the neutral zone is located off-set at a distance from the injection port, empirically the adjustment of the influx of the carrier liquid from both sides into the channel is changed and thus the neutral zone is displaced until the spatial consistency with the injection port is established. Only then the sample is inserted via the injection port, which this way remains trapped in the neutral zone. If the sample comprises particles of differently sizes they are concentrated to a different extent in the direction of the wall of the channel due to the influence of the above-mentioned lateral flow. Thus, already in this operating state a first step of separation of the particles occurs.

In the subsequent third operating state the so-called elution occurs. While the influx of carrier liquid into the channel through the first connection at the first end of the channel is maintained, the influx through the second connection at the opposite second end of the channel is stopped and this second end is now used as the outlet, through which a portion of the carrier liquid inserted via the first connection is drained again, while the remaining portion of the carrier liquid is deviated out of the channel as lateral flow through the permeable section in the wall of the channel. This way, the neutral zone is dissolved and a flow of the carrier liquid spreads over the entire length of the channel in its longitudinal direction from the first connection to the second connection. This leads to the sample and/or its components being entrained by said flow from the location of the former neutral zone, which therefore also forms the starting point or the starting zone, along the channel in the direction towards its second connection.

Here, a flow profile forms, particularly a parabolic one, in which the flow rate is maximal in the center of the channel and approaches zero at the walls. The force field generated by the lateral flow and essentially aligned perpendicular in reference to the longitudinal direction of the channel is pressed by the sample components to be analyzed in the direction towards the permeable section in the wall of the channel. However, due to the different sizes and weights and the different diffusion coefficients connected thereto the larger and heavier particles are pressed stronger in the direction towards the permeable section than the smaller, lighter particles, which are located at a greater distance from the wall of the channel and thus stay rather in the center. This means that the smaller particles reach the faster flow sections of the carrier liquid and thus leave the channel faster through the second connection than the larger particles. Accordingly the retention time of larger particles is longer than the one of smaller particles. In this context it shall be mentioned that the retention time is calculated from the point of time at which the sample components begin to travel from the starting zone at the transfer from the second operating state into the third operating state and thus from focusing to the elution. After being discharged from the channel through its second connection at the second end the sample components and/or particles separated from each other are guided to a sensor, which detects the different sample components and/or particles according to the different retention periods at different points of time.

Using a method known per se for optimizing the separating method for a given sample system via asymmetric field flux fractioning the optimal geometric parameters of the channel and/or the optimal processing parameters for implementing the separating process can be easily determined for the given optimization goal. For this purpose, first using only a test measurement with an already existing channel a fractogram is performed for the sample system using the sample components to be analyzed. Then the retention times are taken from said fractogram, for example for two peaks, which relate to two sample components with different diffusion coefficients to be analyzed. Subsequently the retention time of the first peak is fed to a computer together with the predetermined geometric parameters of the channel and the predetermined processing parameters which have led to the fractogram measured, which computer then via a simulation program calculates from these parameters the diffusion coefficient, which is allocated to the sample component to be analyzed. Finally, using the simulation program, a fractogram is displayed on the monitor, calculated via the simulation program according to the measured fractogram, and all relevant parameters are varied until an optimal fractogram develops on the monitor of the computer.

The localization of the neutral zone forming the starting zone for the sample components during focusing is considered disadvantageous, because it requires an empirical adjustment of the influx parameters of the carrier liquid under simultaneous observation and thus requiring a visual control. However, this is cumbersome, particularly since prior to injecting samples a colorant serving as a marker is required, which leads to an additional processing step and essentially fails to yield reliably reproducible results. In order to even allow the necessary visual control not only the use of a colorant is necessary but of course it is also conditional that the wall of the channel is transparent in the relevant section. Because without any light-permeable embodiment of the wall of the channel an observation and the localization of the neutral zone and/or the starting zone resulting therefrom cannot be performed. If a flat channel is used as the channel, it is surely easily possible in most cases to embody the relevant section of its wall in a transparent fashion; in other embodiments this is possible with difficulty only, based on the design, or impossible when hollow fibers are used, which represents an additional disadvantage. The position of the neutral zone is also important for positioning the injection port at the wall of the channel to inject the sample, which is possible without major problems in a flat channel, however in other embodiments it can only be realized with increased design expense or, as for example in case of the use of a hollow fiber, cannot be realized at all. Finally, the plurality of connections and/or ports aggravates a simple exchange of the channel. Additionally, an exchange for a chromatography column would require a series of time-consuming experimental adjustments.

Further it is known in prior art to use the distribution ratio of the flow volume and/or flow rate of the carrier liquid to the connections at both ends of the channel for localization of the neutral zone and/or the starting zone. Although here the need for a transparent section in the wall of the channel is omitted, and thus the use of a hollow fiber channel is possible, however in prior art the adjustment of the distribution ratio occurs on the one hand in a manual and very cumbersome fashion and on the other hand it represents a rather imprecise localization of the neutral zone and/or starting zone, which in turn has negative consequences upon the measuring results during elution. Due to the fact that for the adjustment of the distribution ratio the channel is removed and subsequently the flow volume and/or flow rate of the carrier liquid dispensed from the then open ports and/or connections is measured with running pumps, therefrom the ratio is determined of the two flow volumes and/or flow rates, and from the distribution ratio in turn the position of the neutral zone and/or starting zone is determined. This represents a very extensive process, which prohibits any constant change of the position of the neutral zone and/or the starting zone required, if necessary; rather this cumbersome process only allows a single adjustment for the respective measuring operation. The fact that this adjustment process is additionally very imprecise is based, among other things, on the measurement being performed with the channel disassembled and in a non-pressurized environment, while the focusing occurs with the channel installed and under pressure and thus under different pressure conditions.

Accordingly the objective of the invention is to provide an improved device and an improved method for field flux fractioning, in which the above-mentioned disadvantages are avoided and/or cannot develop.

This objective is attained according to a first aspect of the invention in a device for field flux fractioning with
a sensor to determine the presence of particles in a carrier liquid,
at least one essentially closed oblong channel, which comprises a first end with a first connection and a second end with a second connection and with its wall comprising at least one section, extending in the longitudinal direction of the channel, which is impermeable for the particles and permeable for the carrier liquid,
a pump, which comprises an inlet and an outlet and which is provided to convey the carrier liquid,
a first liquid path, which connects the outlet of the pump to the first connection of the channel,
a second liquid path, which connects the second connection of the channel to a first switching means, through which the second liquid path can be connected in a first switch position to the outlet of the pump and in a second switch position to the sensor,
an injection device arranged in the first liquid path and provided for the injection of a sample comprising particles into the carrier liquid flowing through a first liquid path, and
a flow volume distribution device, which divides the flow volume conveyed by the pump in the first switch setting of the first switching means in a predetermined ratio over the first liquid path and the second liquid path and comprises a first flow volume control device, which is arranged in the first liquid path and provided to control the flow rate of the carrier liquid in the first liquid path (6) and comprises a first valve to adjust the flow rate of the carrier liquid in the first liquid path,
   characterized in that
the first flow volume control device comprises a first measuring device to measure the flow volume of the carrier liquid,
the valve is arranged upstream in reference to this first measuring device and is provided for controlling the flow volume of the carrier liquid in the first liquid path in consideration of the measurements of the first measuring device, and
the pump is provided to convey the carrier liquid in a volume that can be precisely dosed.

Further, the above-stated objective is attained according to a second aspect of the invention in a method for field flux fractioning with the steps
conveying via a pump a carrier liquid, provided to accept a sample comprising particles, through a first liquid path to a first connection of at least one essentially closed oblong channel, which comprises a first end with a first connection and a second end with a second connection and with its wall comprising at least one section extending in the longitudinal direction of the channel, impermeable for the particles and permeable for the carrier liquid, through the first connection of the channel into said channel,
further conveying the carrier liquid via the pump through a second liquid path to the second connection of the channel and through the second connection of the channel also into the channel, with the flow volume overall conveyed by the pump being divided in a predetermined distribution ratio over the first liquid path and the second liquid path,
injecting a sample comprising particles into the portion of the carrier liquid conveyed through the first liquid path, and
subsequently interrupting the connection between the pump and the second liquid path and thus the conveyance of the carrier liquid in the second liquid path and instead connecting the second liquid path to a sensor for determining the presence of particles in the carrier liquid, causing the particles contained in the carrier liquid to be drained from the channel through its second connection and the second liquid path towards the sensor,
   characterized in that the flow volume of the carrier liquid dispensed by the pump is adjusted or regulated to a predetermined value and the flow volume of the carrier liquid is measured in the first liquid path and controlled or regulated to a predetermined value in consideration of a measurement yielded there.

Accordingly, the invention offers a simple and simultaneously effective option to determine the position of the neutral zone and, if necessary, adjust it in a defined fashion, since this point forms the starting zone for the sample components at the beginning of the elution. According to the invention it has been found that without using any visual control merely by predetermining and/or adjusting the ratio of the flow volume of the carrier liquid conveyed by the pump to the first path, from which the carrier liquid is pumped through the first connection at the first end into the channel and the second liquid path, from which during focusing the carrier liquid is pumped through the second connection at the other and/or second end in the opposite direction into the channel, from which the relative position of the neutral zone and, in case of a known length of the channel (distance between the first connection and the second connection) and perhaps also in consideration of the particular geometry of the channel also the path length traveled by the sample components can be determined during the elution up to the second connection in the channel, and thus also the absolute position of the neutral zone and/or the starting zone. If for example the distribution ratio amounts to 1:9, i.e. 10% of the overall flow volume of the carrier liquid conveyed by the pump is pumped into the channel through the first connection and 90% of the flow volume through the second connection then the neutral zone is formed at a position which is located at a distance of 10% of the overall length of the channel from the first connection. If in this example the length of the channel between the first connection and the second connection amounts to e.g., 40 cm, it must be assumed that the position of the neutral zone is located at a distance of 4 cm from the first connection and/or at a distance of 36 cm from the second connection in the channel. Optic control methods as used in prior art or other measuring methods are therefore not necessary when using the invention.

Additionally, the invention allows an adjustment and/or regulation of the distribution ratio in order, if necessary, to predetermine different positions for the neutral zone and/or starting zone. Here, the flow volume of the carrier liquid is measured in the first liquid path and adjusted to a predetermined value in consideration of a measurement of the distribution ratio yielded. For this purpose, the flow volume—distribution device comprises a first flow volume—control device, which is arranged in the first liquid path. According to the invention, in consideration of the measurement, only the flow volume of the carrier liquid is controlled or regulated in the first liquid path to a predetermined value, while the flow volume of the carrier liquid in the second liquid path is predetermined fixed and constant. In order to adjust the flow volume of the carrier liquid in the first liquid path the first liquid volume—control device comprises a valve and a measuring device and the valve is arranged downstream in reference to this measuring device.

In order to yield the desired reliability and precision of the measurements the flow volume of the carrier liquid dispensed by the pump, which represents the entire flow volume conveyed, must be precisely dosed. In this context the invention allows, if necessary, a precise measurement of the conveyance by the pump in a simple fashion and thus the overall flow volume of the carrier liquid dispensed by the pump, with here the entire carrier liquid being guided only through the first liquid path. Here, it must be ensured that any drainage into the second liquid path and to the sensor is prevented and thus in this case the second liquid path as well as the path leading to the sensor must be closed. Such a temporary operating state can be realized particularly in that a third switch setting is provided for the first switching means, in which the connections to the second liquid path and the sensor are simultaneously blocked, or valves are used for an optional closing of the second liquid path and the path leading to the sensor. In such a measuring operation then the first measuring device provided in the first liquid path can be used in a clever fashion for a precise measuring of the conveyance by the pump and thus the entire flow volume of carrier liquid dispensed by the pump overall. In particular, in such a measuring operation deviations can be determined, which for example occur based on pressure differences in the section of the first liquid path extending from the pump to the first measuring device and/or which are a consequence of wear and tear in the pump. If such changes are detected a correcting factor can be determined and used for adjusting the distribution ratio in order to appropriately compensate these changes by way of calculation. Upon conclusion of such a temporary measuring operation then normal operation is reestablished, in which the flow volume of the carrier liquid is controlled in the first liquid path considering the measuring results of the first measuring device.

The invention therefore not only provides a very precise control of the distribution ratio, from which a precise localization of the neutral zone and/or starting zone is discernible during the focusing, but it also allows a rapid change of the distribution ratio, if necessary, and the position of the neutral zone and/or starting zone resulting therefrom while upholding the desired high measuring precision and here the resulting option for a precise localization of the neutral zone and/or starting zone.

Further, by the invention the embodiment of an injection port is omitted in the wall of the channel. Rather, according to the invention the injection of the sample occurs upstream in reference to the channel, namely in a liquid path leading from the pump to the first connection of the channel. The sample is inserted into the channel therefore by a carrier liquid which transports the sample out of the first liquid path into the channel through its first connection. During focusing the neutral zone forms, because carrier liquid is pumped not only through the first connection at the first end of the channel into said channel but simultaneously also in the opposite direction through the second connection at the oppositely located other and/or second end. After the sample has been transported by the carrier liquid through the first connection into the channel, the sample remains in the neutral zone formed in the meantime and stays here until the second operating state and thus the focusing ends and the third operating state and thus the elution starts. This results in a simple possibility for exchanging the channel, because the communication of the channel with the other aggregates of the device for field flux fractioning occurs only via two connections, which must be appropriately detached or connected, namely the first connection, which forms the flow inlet both during focusing as well as during elution, and the second connection, which during focusing forms another opposite flow inlet or the flow outlet during elution.

Thus, when using the invention both the injection port at the channel as well as the embodiment of a transparent section in the wall of the channel is omitted. Here, for the first time a real practical option is provided for using channels for field flux fractioning in a much less restricted constructive embodiment than in prior art and particularly also the use of a hollow fiber for the channel. A speedy, uncomplicated change from a flat channel and a hollow fiber and the occasional use of chromatography columns represent an important requirement to allow utilizing the (entire) potential of field flux fractioning in practice. Hollow fibers are extremely cost-effective compared to other channel constructions. Flat channels are particularly well suited for samples with particles, which yield a very weak detection and/or sensor signal and simultaneously show diameters of more than 300 nm; in this case the sample amount in the flat channels can be increased without reducing the quality of the chromatogram. Chromatographic columns serve to understand chromatograms, which were produced by third parties using chromatography columns and in which the further analysis of the particle sizes is necessary.

In order to switch from focusing to elution the first switching means is provided by which the second liquid path connects the second connection of the channel. This first switching means can be switched between a first switch position and a second switch position. In a first switch position the first switching means couples the second liquid path to the outlet of the pump in order to pump the carrier liquid additionally via the second connection into the channel; the first switch position is therefore selected for focusing. In its second switch position the first switching means couples the second liquid path to the sensor; the second switch position is selected for elution in order to now guide the carrier liquid with the sample particles contained therein dispensed out of the channel through the second connection to the sensor which detects the sample components.

Another essential advantage of the invention comprises that for the operation of the device and the method both during focusing as well as during the elution only a single pump is required, which here dispenses the entire required flow volume of carrier liquid, which is divided to the first liquid path and the second liquid path in the first switch position of the first switching means during focusing in a predetermined distribution ratio. For the precise determination of the distribution ratio of the flow volumes of the carrier liquid over the two liquid paths and a precise localization of the neutral zone and/or the starting zone resulting therefrom during focusing it is advantageous that the value of the flow volume of the carrier liquid overall available in the system and conveyed by the pump is precisely known so that the carrier liquid should be conveyed by the pump in a precisely dosed flow volume. The use of a single pump not only leads to a simplification of the method and the design of the device required here, but also ensures the dispensing of the carrier liquid with a defined constant flow volume. Furthermore, the omission of pulsations of the liquid volume is minimized, and thus also any pressure fluctuations in the channel connected thereto. Here, only the dispensing of a defined constant overall flow volume from one and the same source ensures that the distribution over the first liquid path and the second liquid path occurs at the desired defined distribution ratio.

Preferred embodiments and further developments of the invention are disclosed in the dependent claims.

Beneficially the flow volume of the carrier liquid dispensed by the pump should be controlled to a certain value. For this purpose a control unit shall be provided for a controlled conveyance of the carrier liquid by the pump, with the control unit preferably forming a structural unit with the pump or being integrated in the pump such that in the latter case the pump dispenses the carrier liquid with a flow volume already controlled to a predetermined value.

In another preferred embodiment of the invention, depending on the measurement representing the flow volume of the carrier liquid in the first liquid path and the input of a target value stating the desired distribution ratio, the flow volume of the carrier liquid in the first liquid path is appropriately controlled, with here the provision of a control device being required, which respectively controls the first valve. In order to increase the control precision preferably also the flow volume of the carrier liquid dispensed by the pump should be measured and additionally, depending on a measurement resulted therefrom, regulation should be performed. Here, for the precision of the adjustment and the determination of the distribution ratio and the localization of the neutral zone and/or starting zone resulting therefrom the precise flow volume and/or flow rate of the carrier liquid overall conveyed by the pump should be known.

Preferably the sample is injected into the first liquid path at a position downstream in reference to the point at which the measurement and/or the control and/or regulation is performed, with here the injection device being arranged downstream in reference to the first flow volume—control device.

Beneficially, a second switching means may be provided by which the injection device optionally can be connected and/or disconnected from the first liquid path.

The portion of the carrier liquid dispensed from the liquid-permeable section of the channel is preferably guided off by a third liquid path. In a further development of this embodiment the flow volume of the carrier liquid can be controlled or regulated to a predetermined value in the third liquid path, which is advantageous for the entire flow balance in the device. For this purpose, in the third liquid path a second flow volume—control device may be arranged, which is provided to control the flow volume of the carrier liquid in the third liquid path. The second flow volume—control device may comprise a valve, preferably a magnetic valve, to adjust the flow volume of the carrier liquid in the third liquid path. Preferably the flow volume of the carrier liquid is measured in the third liquid path and, considering the measurement yielded here, the flow volume of the carrier liquid in the third liquid path is controlled or regulated.

In another embodiment of the invention, during the conveyance of the carrier liquid in the second liquid path, carrier liquid is conveyed additionally by the pump to the sensor. Such a measure serves to rinse the detector and/or the sensor during focusing. Here, flow changes in the sensor may cause so-called base line drifts at said sensor, which only slowly subside over time, leading to an undesired drift of the base line of chromatograms. For this purpose, the first switching means may be preferably embodied such that in its first switch position for focusing it couples the outlet of the pump both to the second liquid path as well as to the sensor.

For example a flat channel with a preferably rectangular cross-section (seen in the direction of flow) may be used as the channel and a membrane, which shows a particular trapezoidal form (seen in the top view).

Further, if necessary a channel may be used, with its entire wall being essentially impermeable for the particles and embodied permeable for the carrier liquid. This may particularly represent a hollow fiber. The advantages of the present invention are particularly discernible when such an embodiment is used. For the first time it is possible with the use of the invention to apply a hollow fiber for a method of field flux fractioning and to implement it in a reliable fashion; in this case the method may also be called hollow fiber—field flux fractioning (HFFFFF and/or HF5).

Beneficially several channels may be provided and from this plurality of channels optionally one channel is activated to perform the method. Preferably the channels are embodied in an interchangeable fashion.

At least one unused channel may be rinsed for cleaning when it is not activated to perform the method. For this purpose, at least one rinsing device which can be switched on or off may be provided to rinse the unused channel. It has been found that particularly by continuous rinsing the time until readiness for use and/or measurement of a channel can usually be considerably shortened because here disturbing residue, such as bacterial lawn can be removed from the channel after changing samples or the precipitation of such residue in the channel can be largely prevented right from the start. In this context the adhesion of components from the carrier liquid is of importance as well, with the adhesion may depend on the strength of the flow, with here additionally a disturbing drift can be generated in the detector and/or sensor.

When using a plurality of channels preferably a third switching means is provided for the optional activation of a channel from said multitude of channels. In a further development of this embodiment the rinsing device is connected to the third switching means and can be connected thereby to at least one of the unused channels.

In addition to at least one channel, at least one chromatography column may be provided and optionally either one channel or one chromatography column may be activated to perform the method. For this purpose preferably a fourth switching means is used for an optional activation of either a channel or a chromatography column. In a further development of this embodiment at least one rinsing device can be connected to the fourth switching means or can be connected thereby to at least one unused channel and/or at least one unused chromatography column.

Beneficially, the above-mentioned third switching means and the above-mentioned fourth switching mans may form a joint switching means.

In the following preferred exemplary embodiments of the invention are explained in greater detail based on the attached drawings. It shows:

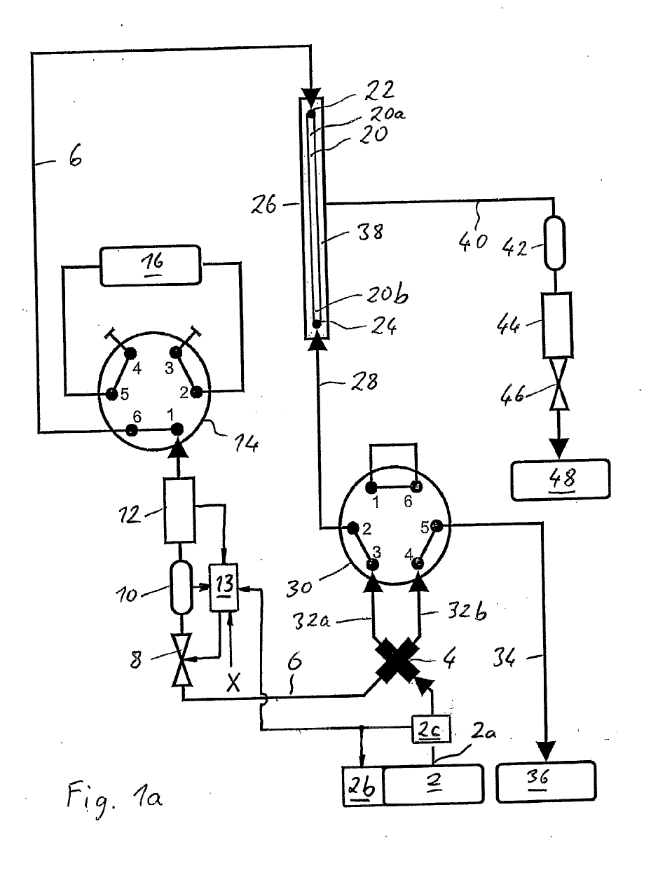

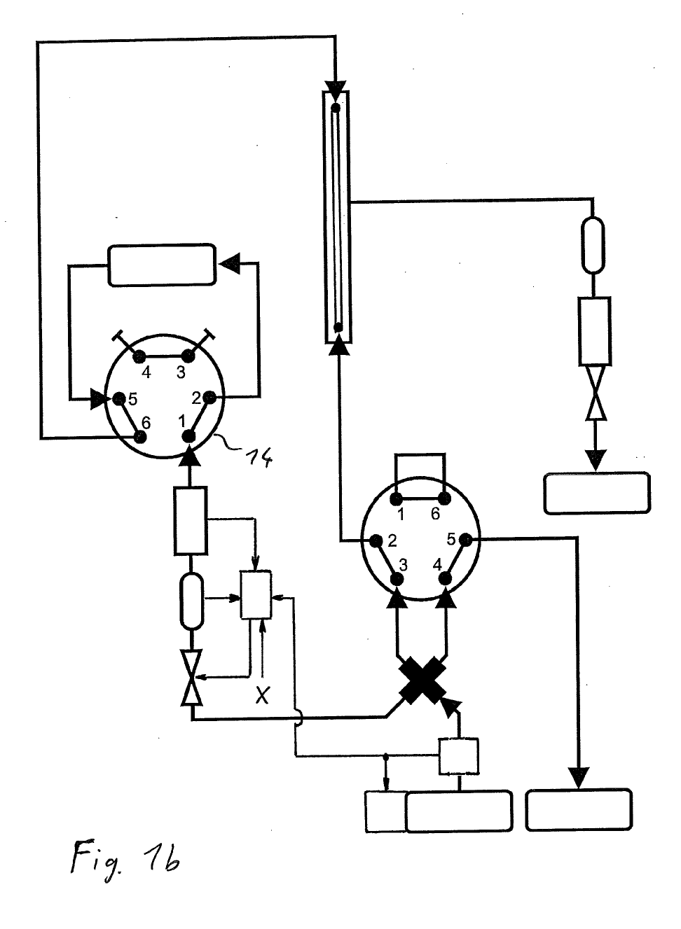

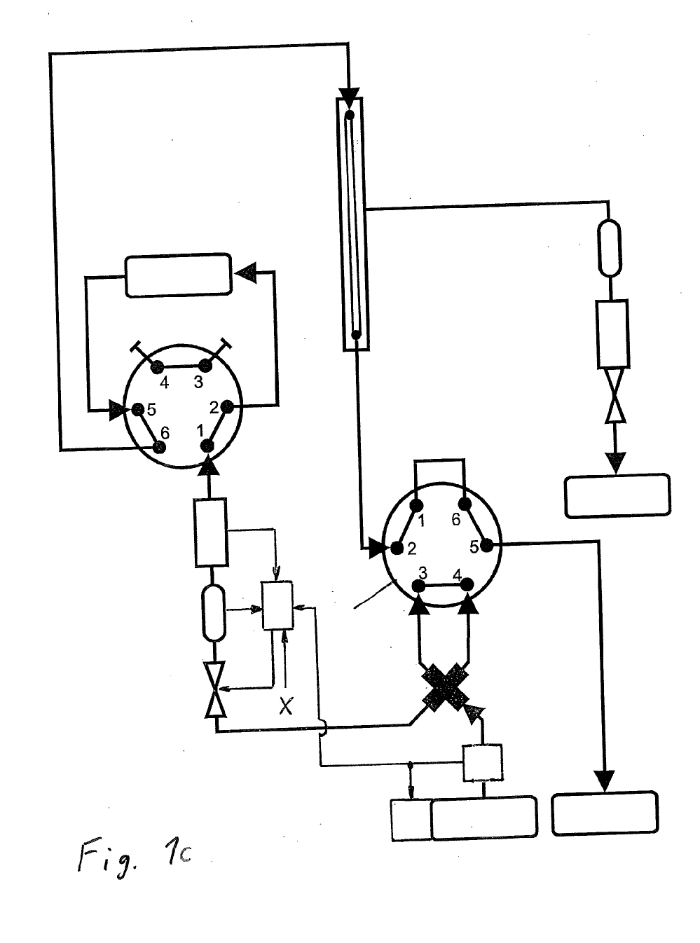

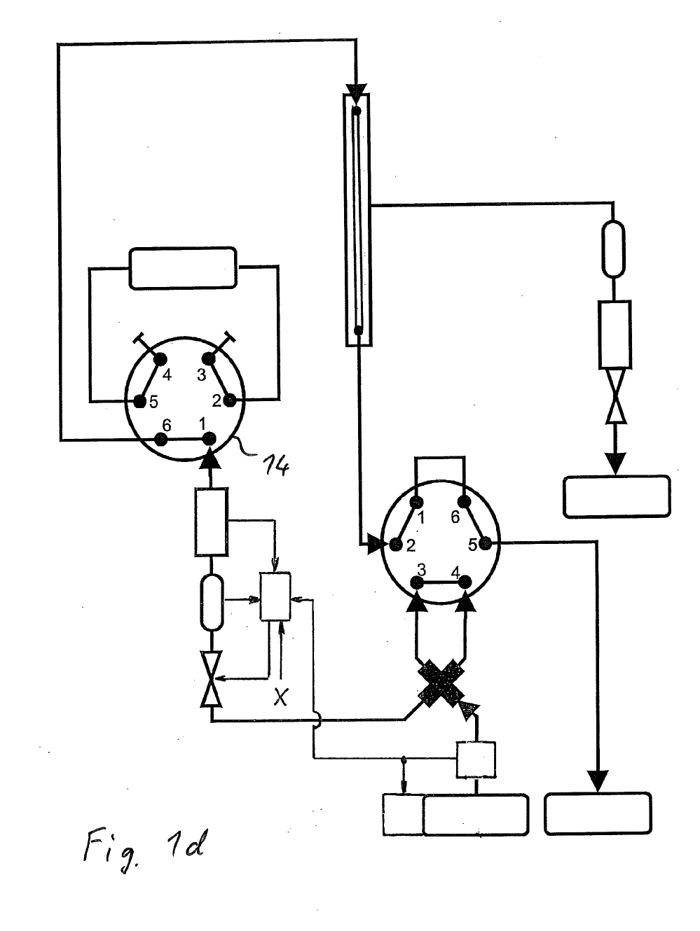

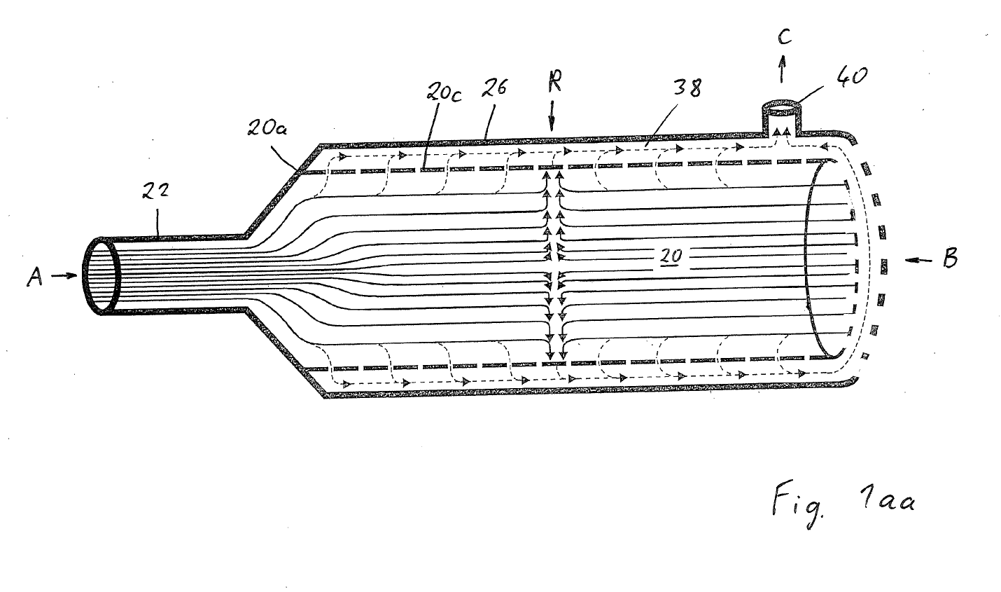

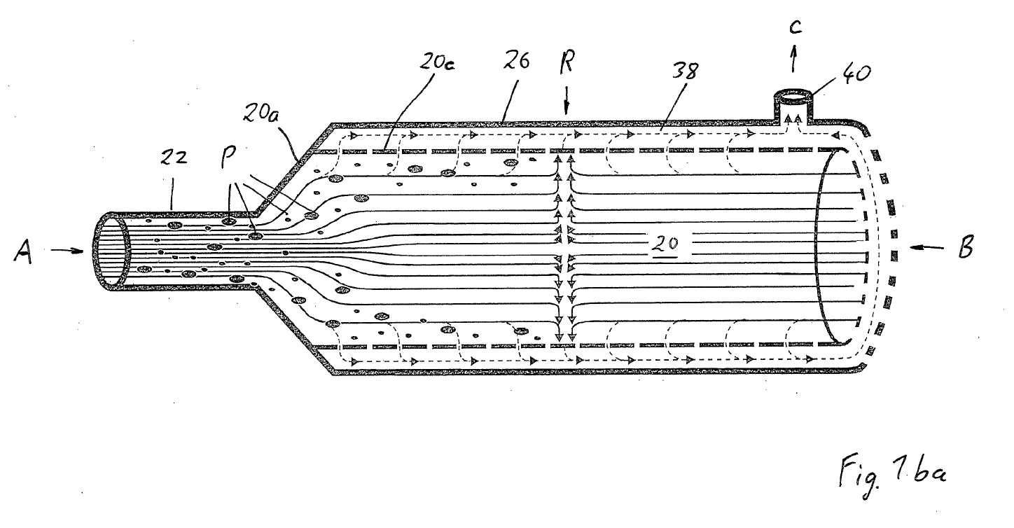

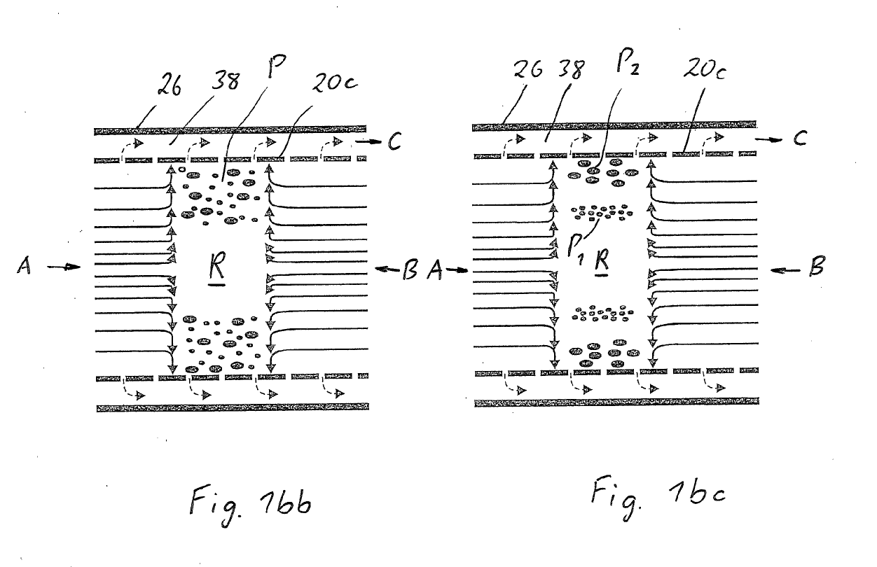

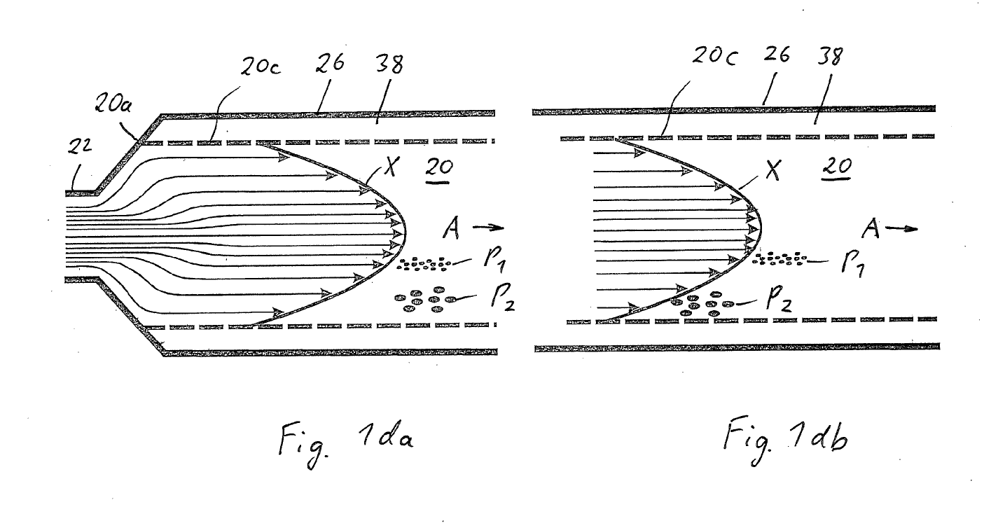

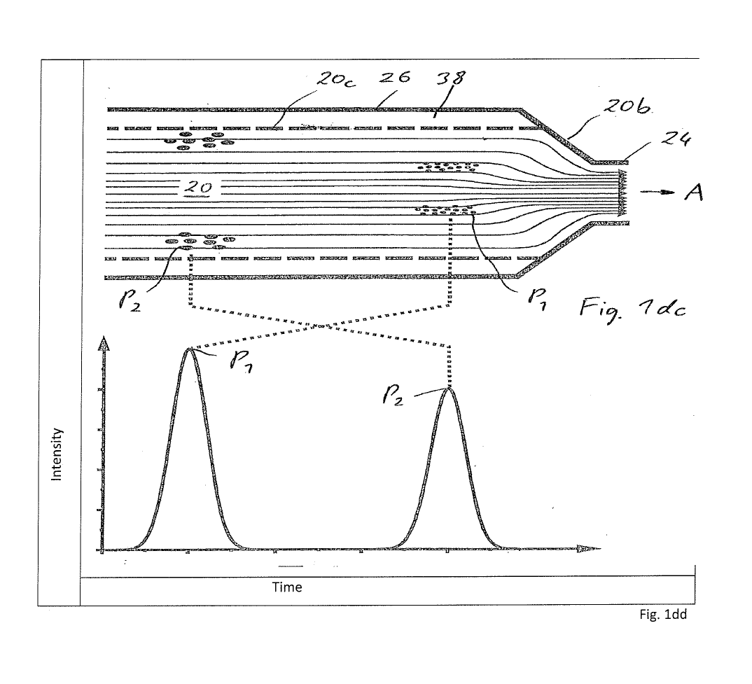

FIGS. 1a to 1d: a first embodiment of a device for field flux fractioning according to the present invention with a hollow fiber being used as the channel in four different operating states;

FIGS. 1aa to 1dd: the various steps of the separating method in schematic illustrations;

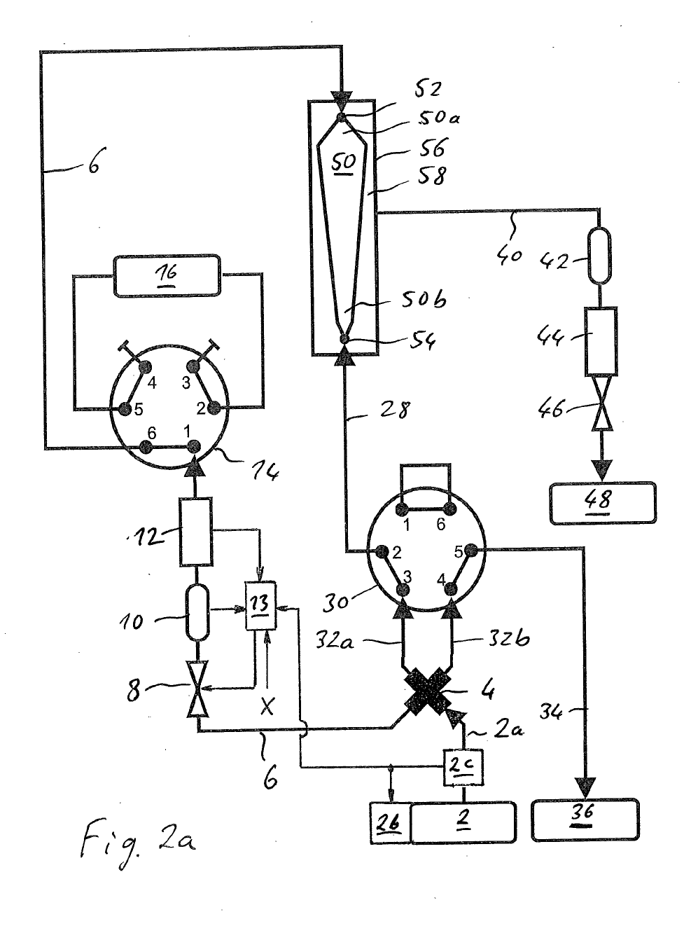

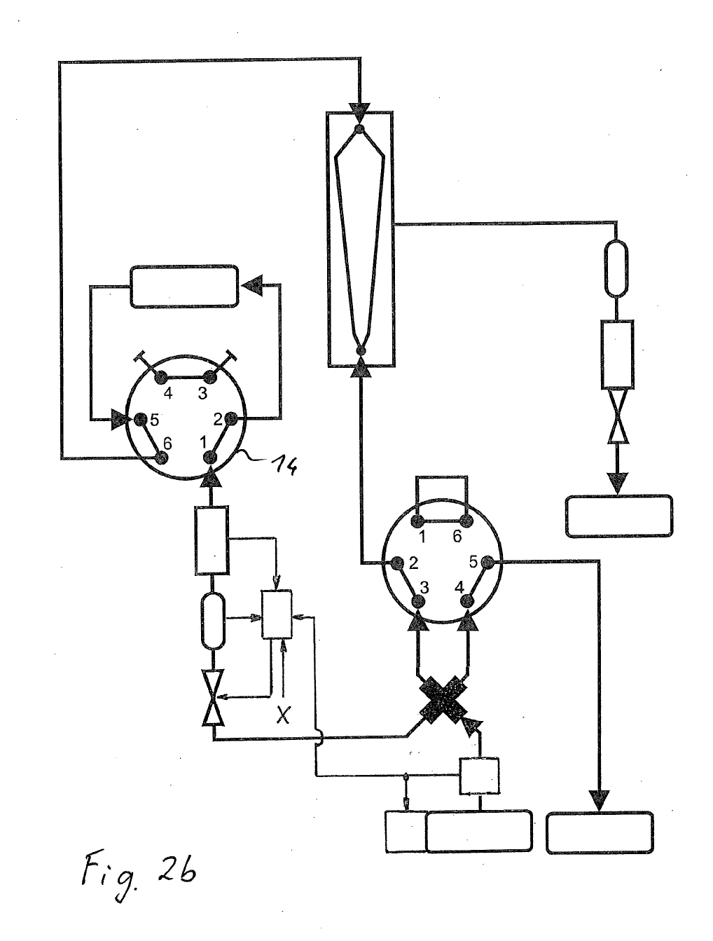

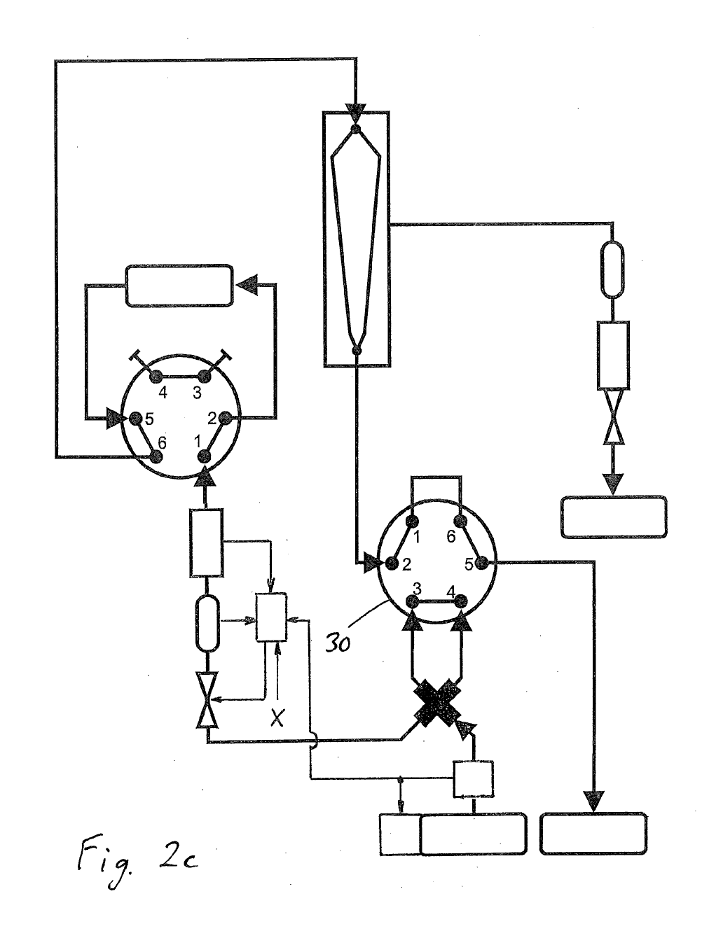

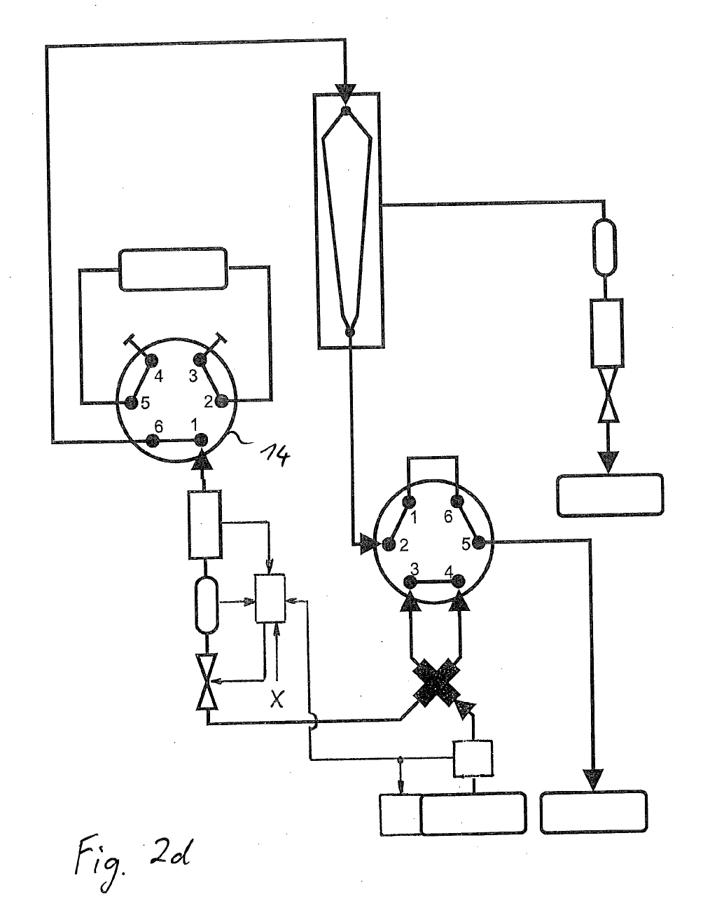

FIGS. 2a to 2d: a second embodiment of a device for field flux fractioning according to the present invention with a flat channel in various operating states;

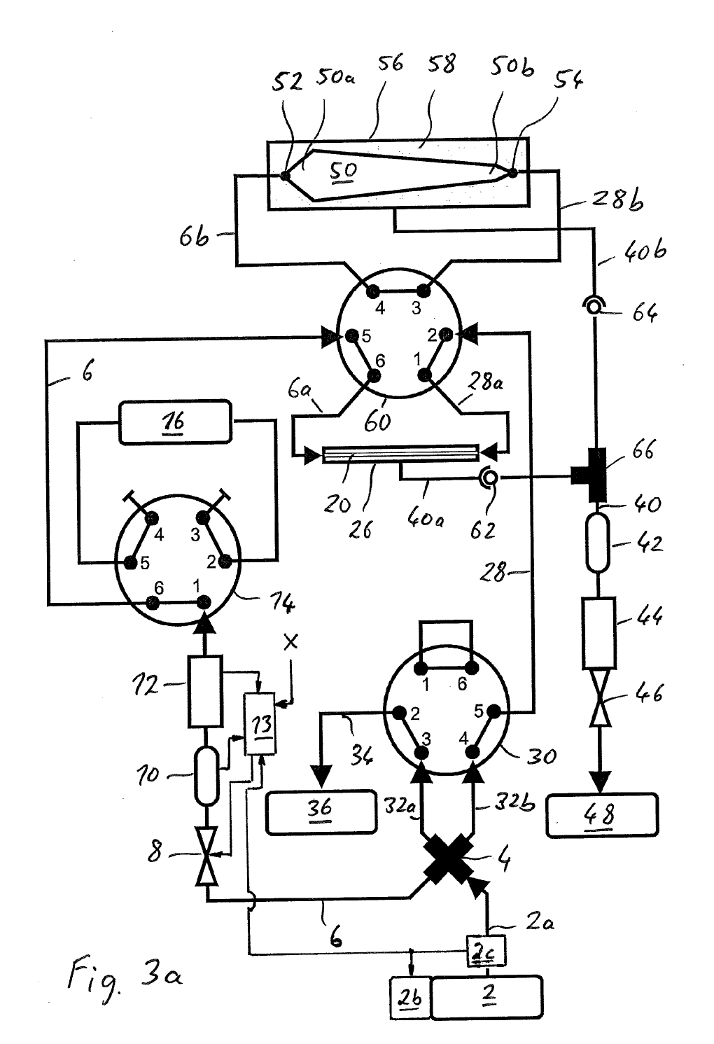

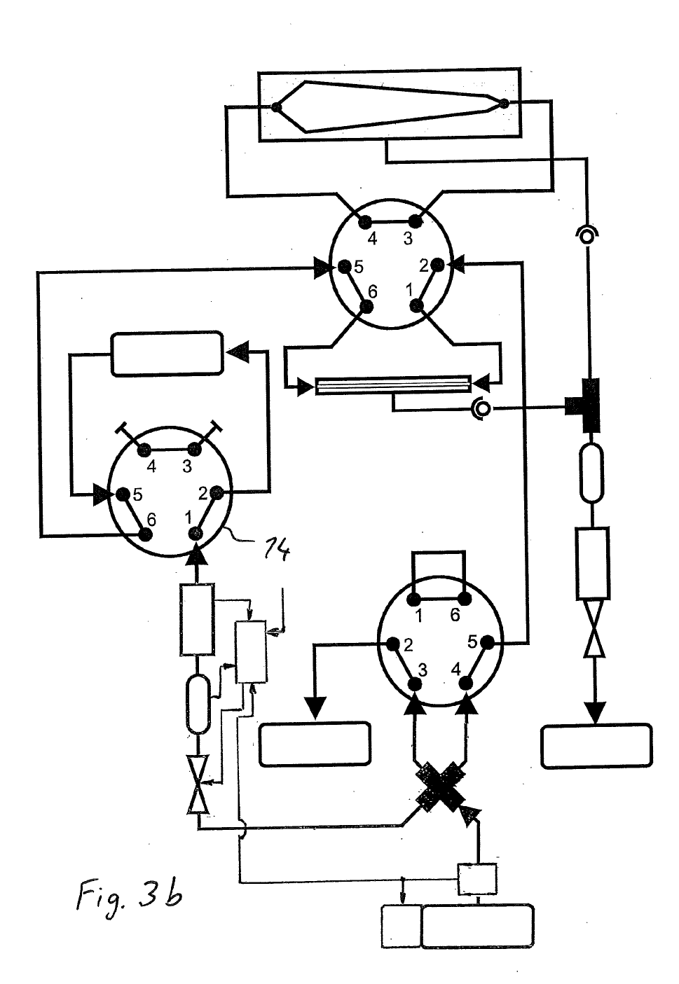

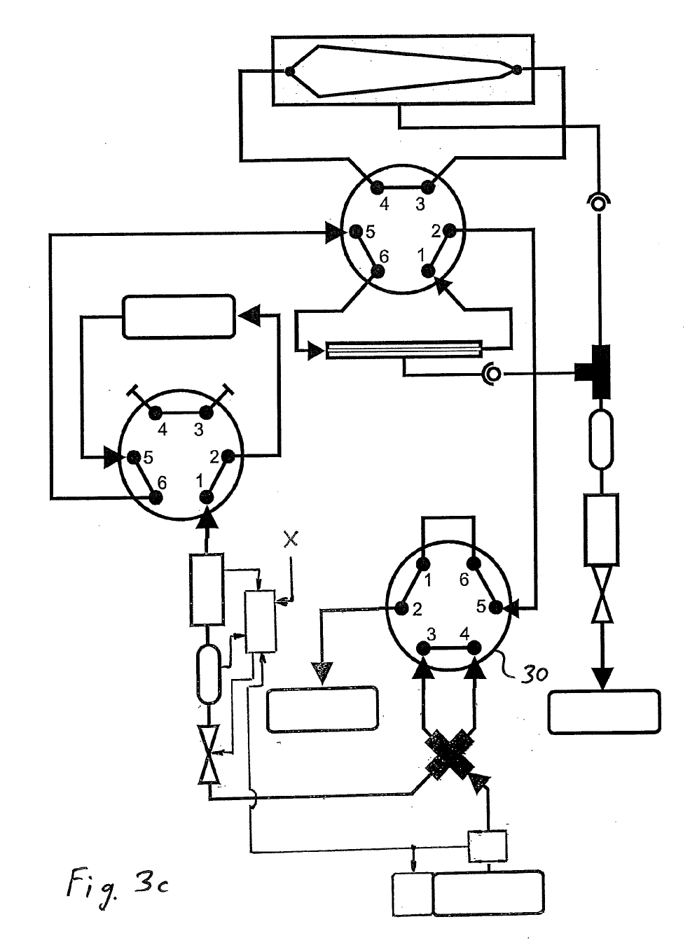

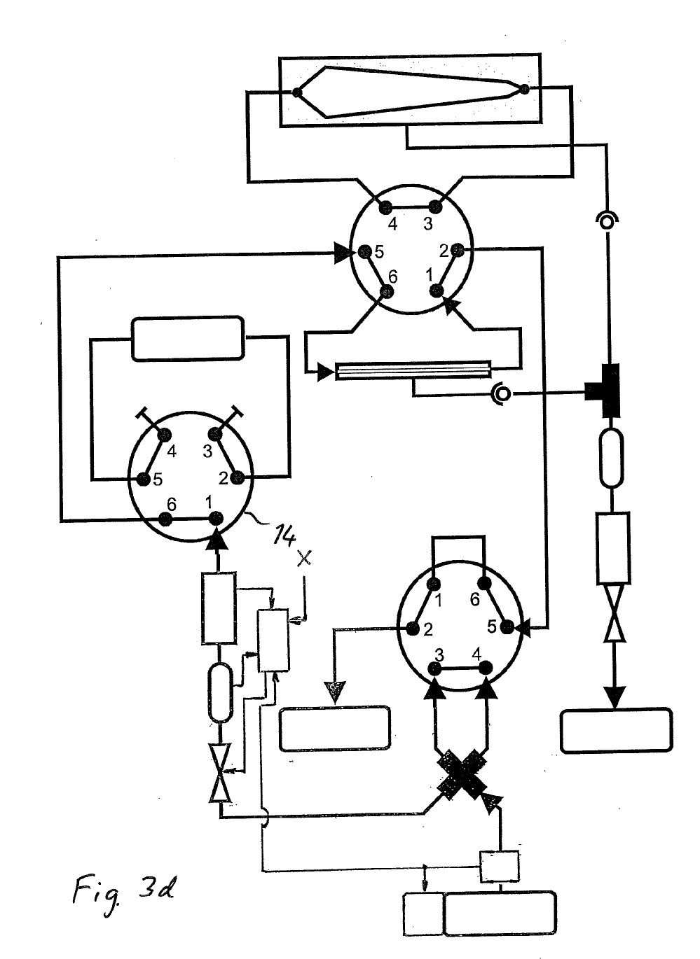

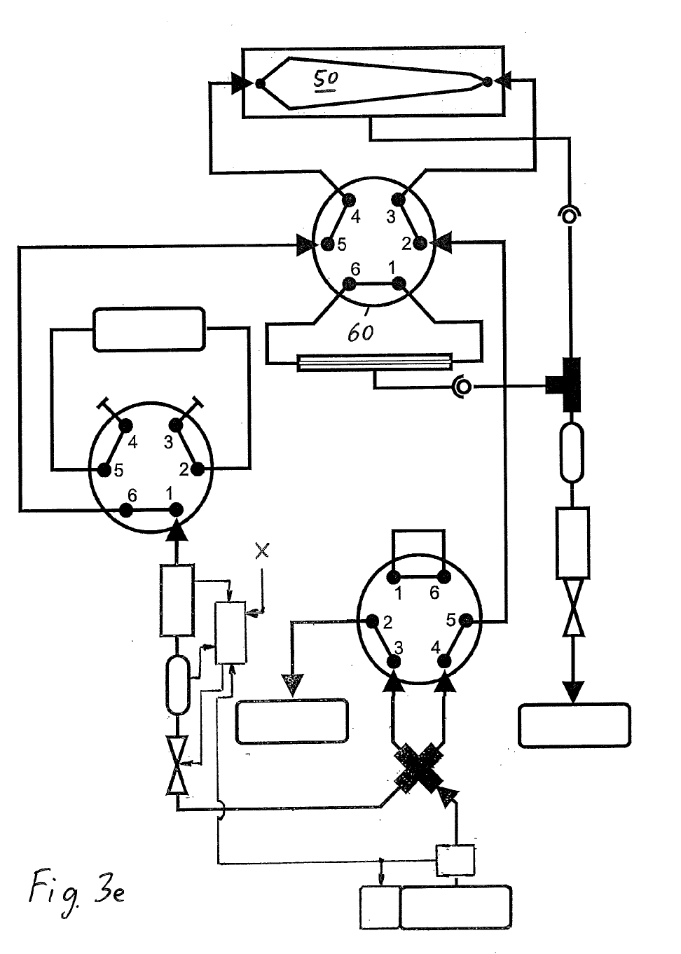

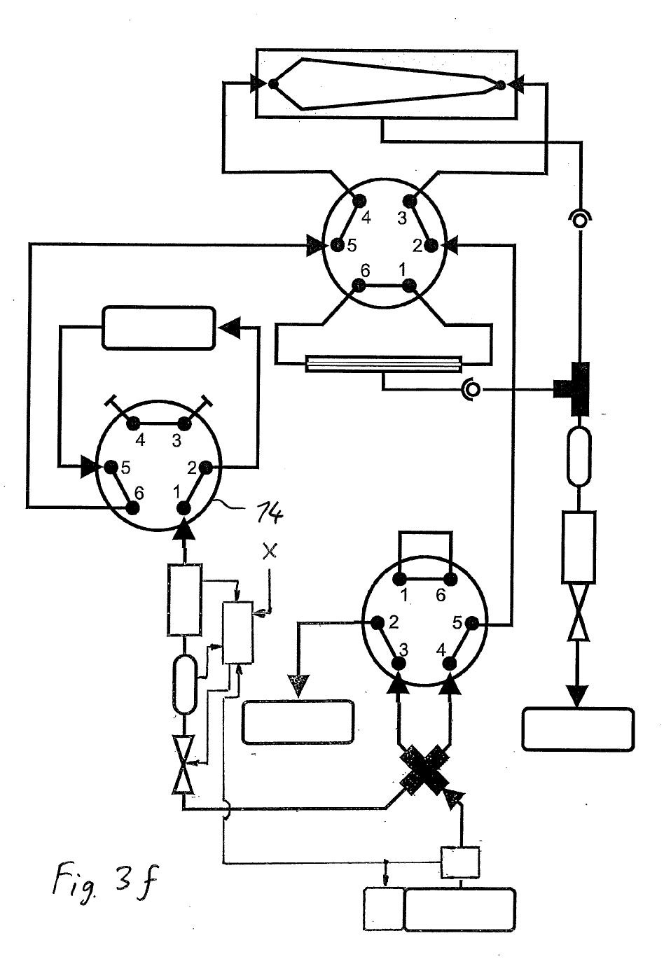

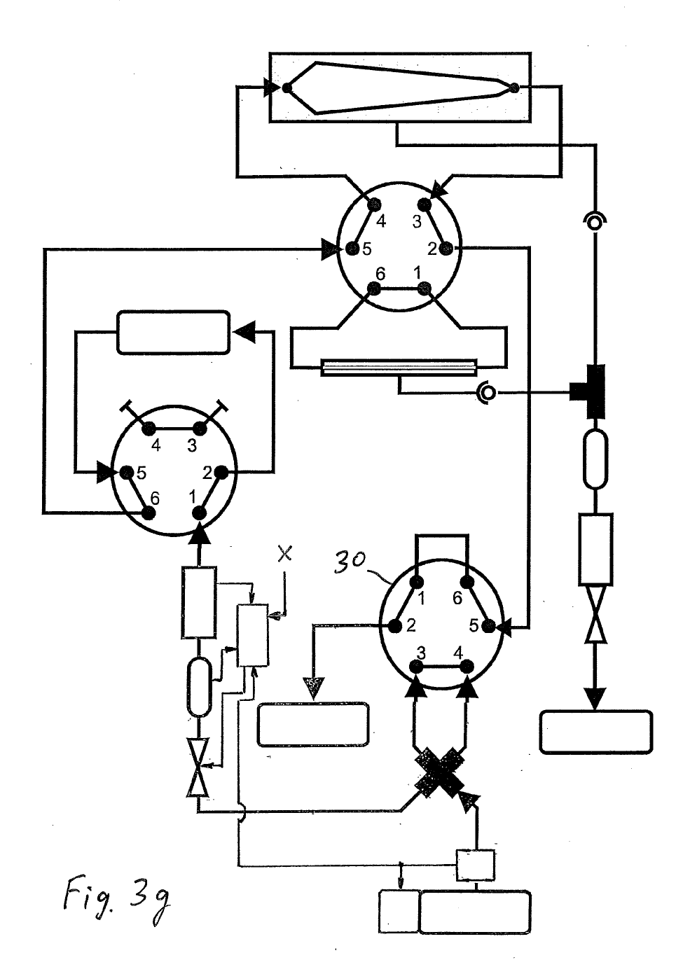

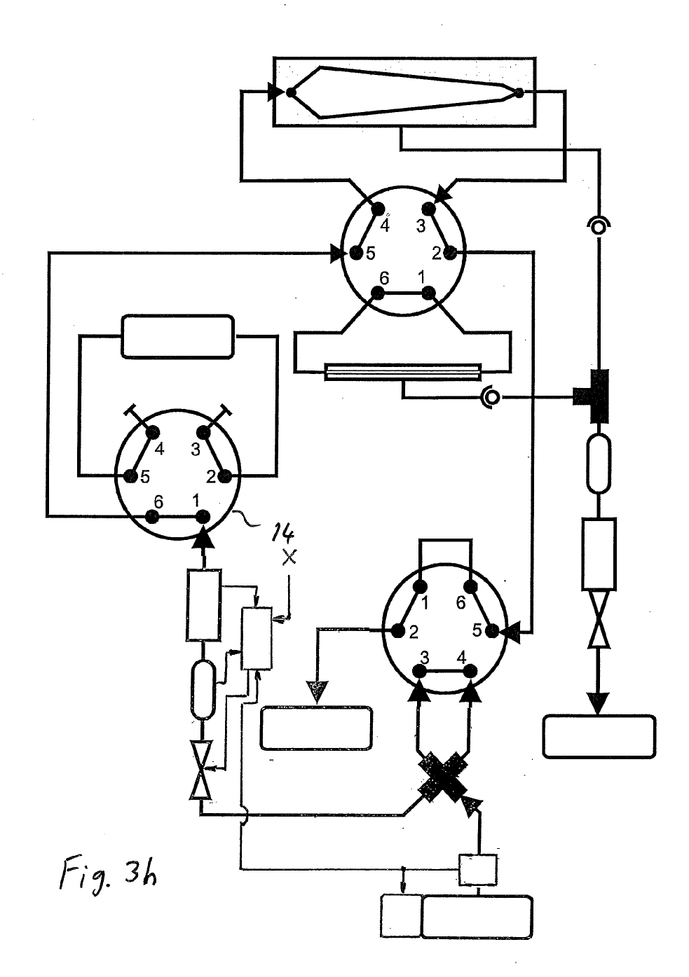

FIGS. 3a to 3h: a third embodiment of a device for field flux fractioning according to the present invention with a hollow fiber being used as the channel and a flat channel in various operating states;

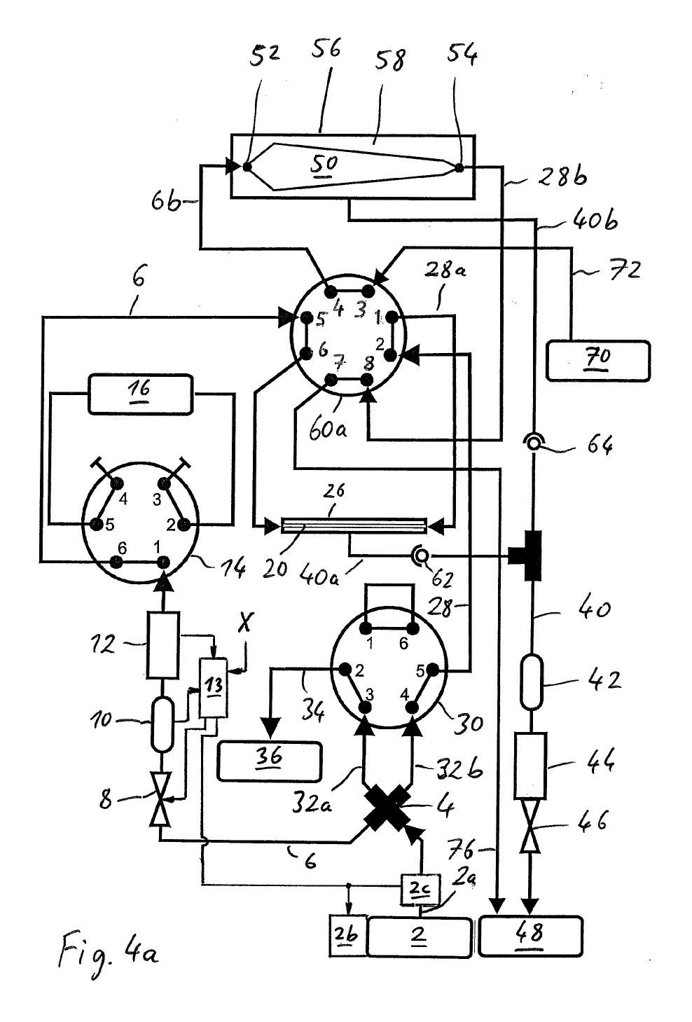

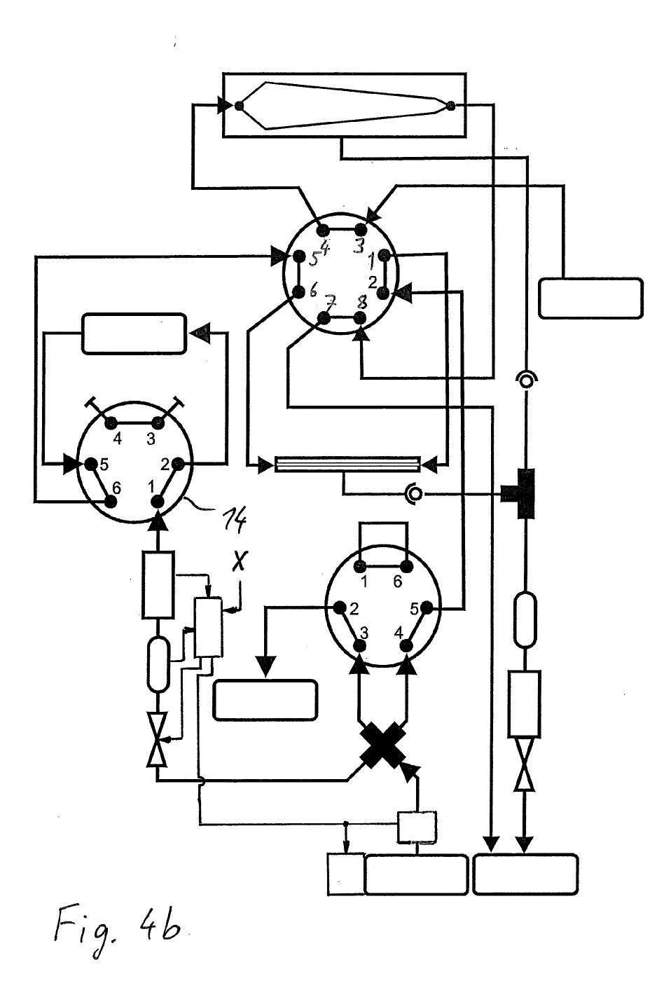

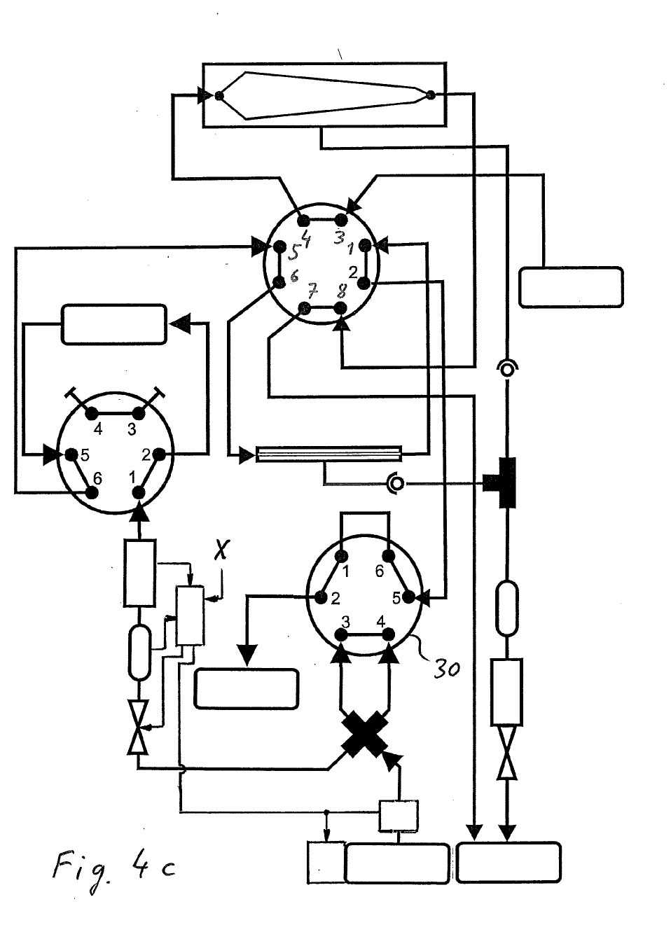

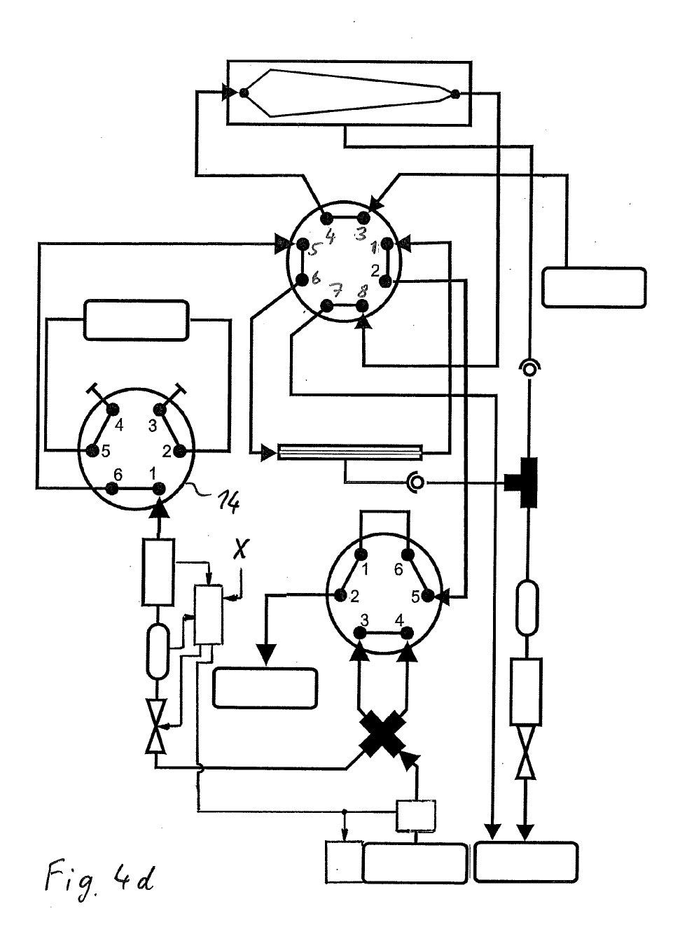

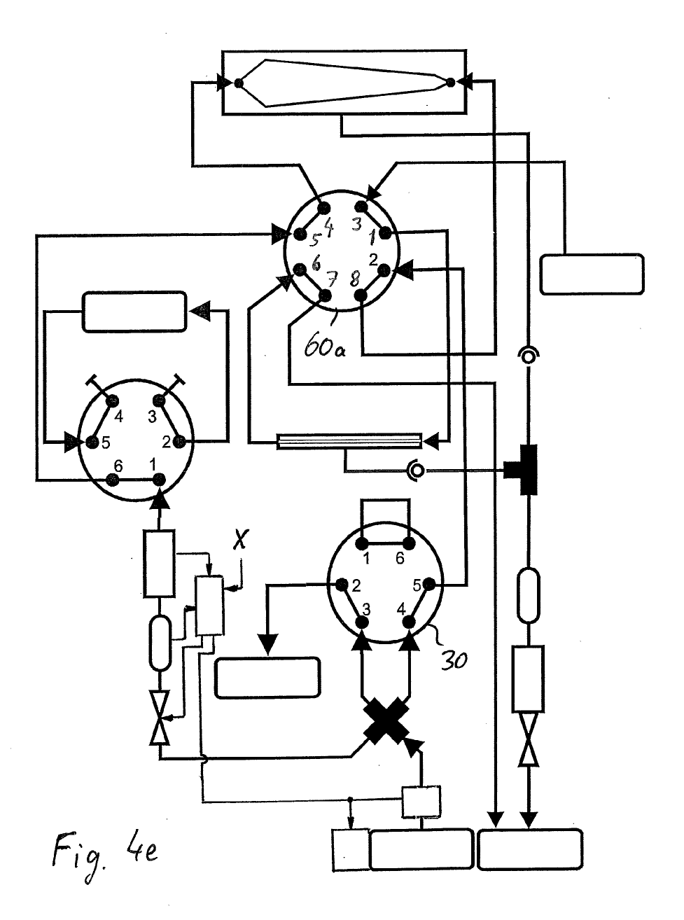

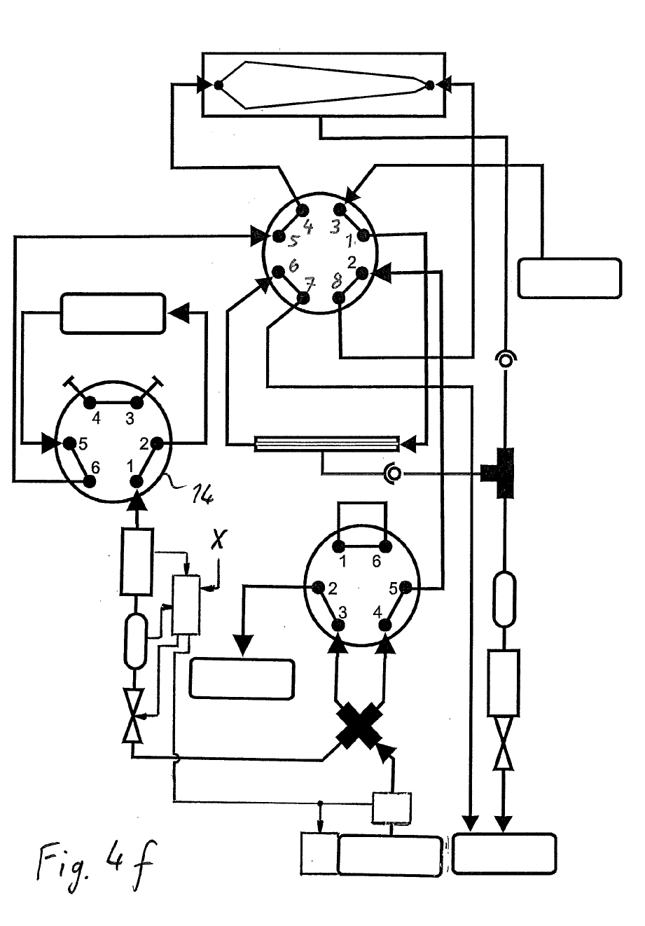

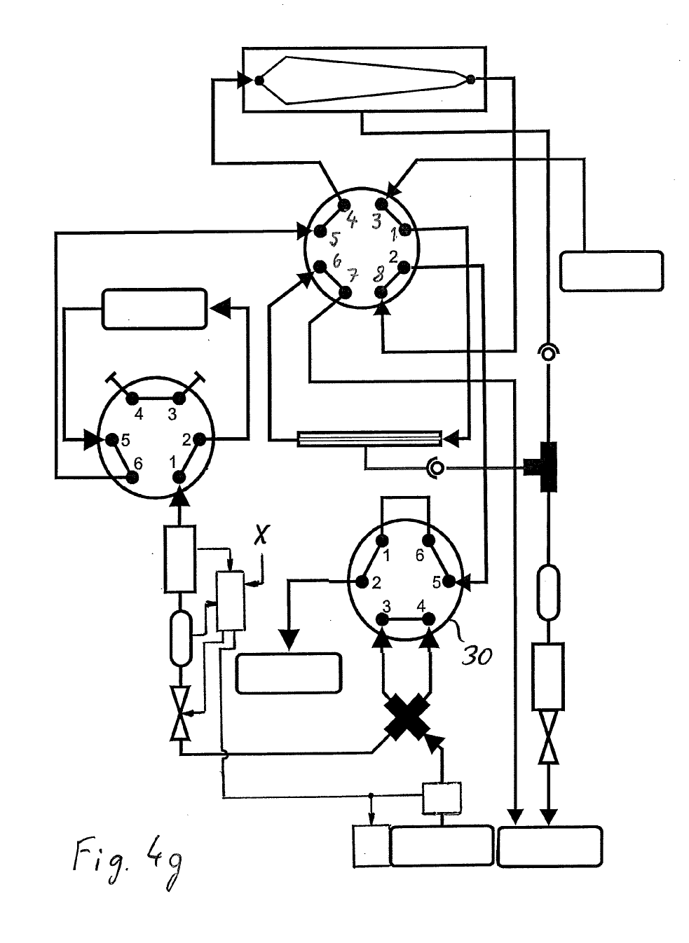

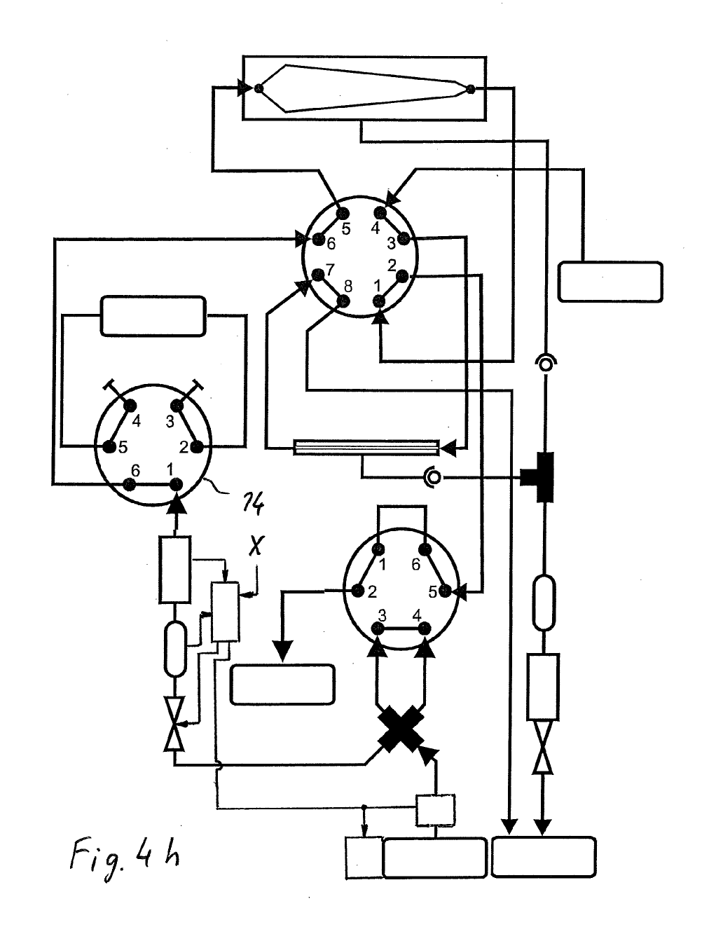

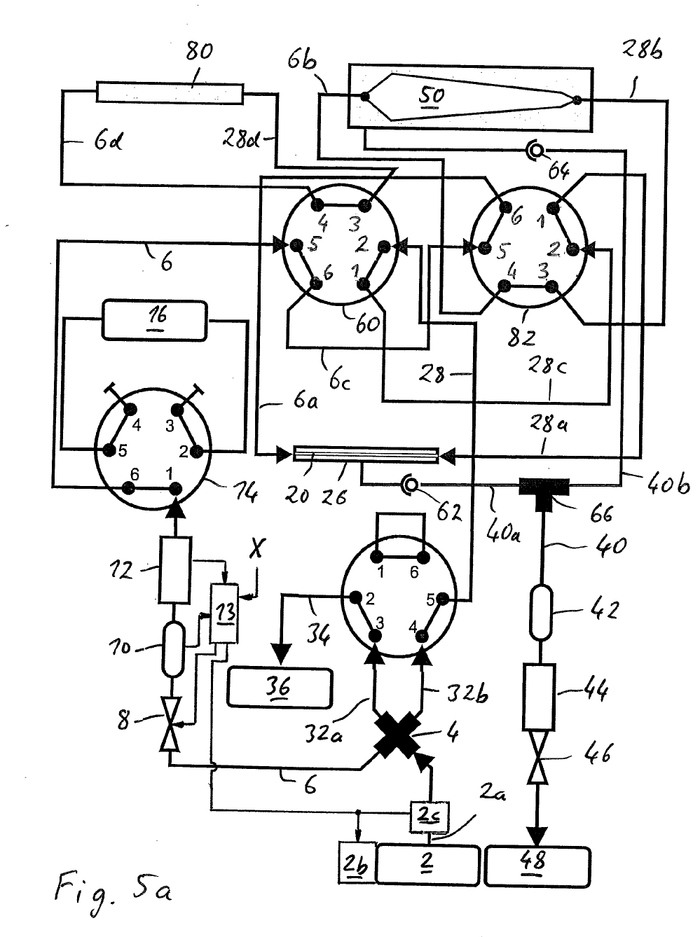

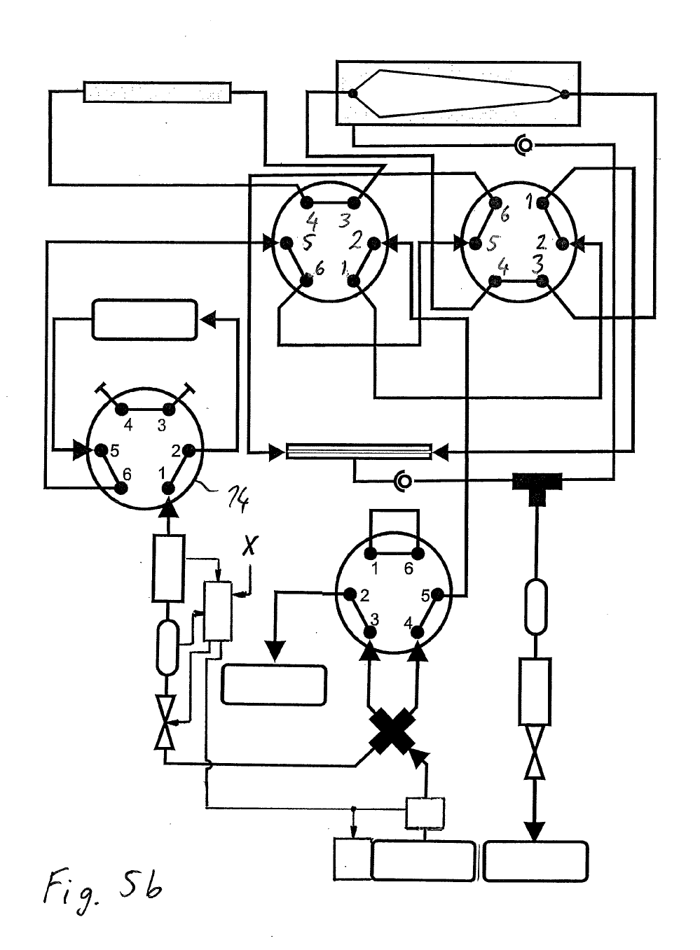

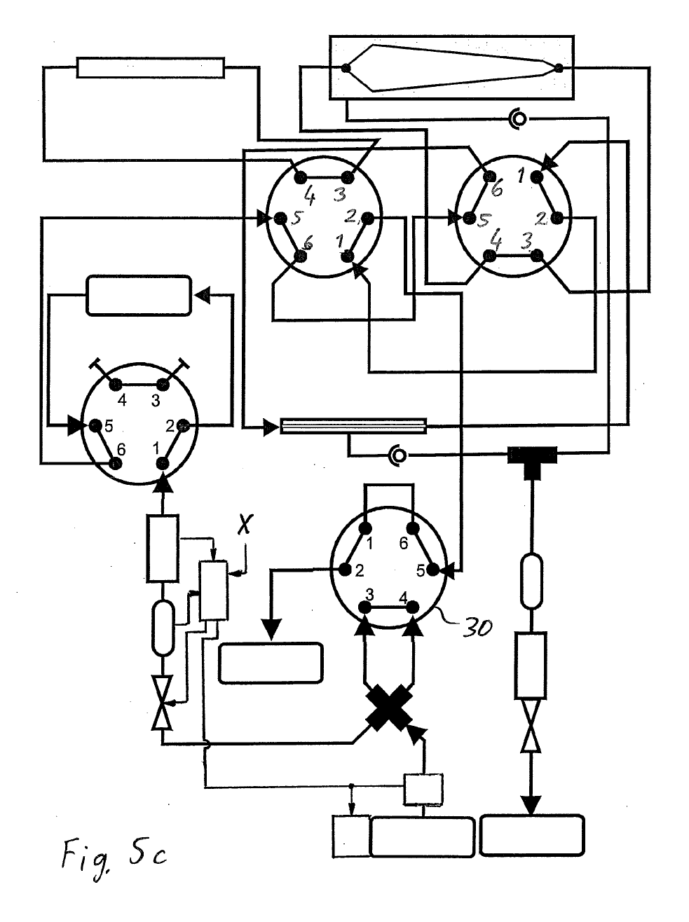

FIGS. 4a to 4h: a fourth embodiment of a device for field flux fractioning according to the present invention with a hollow fiber being used as the channel, a flat channel, and a rinsing device in various operating states;

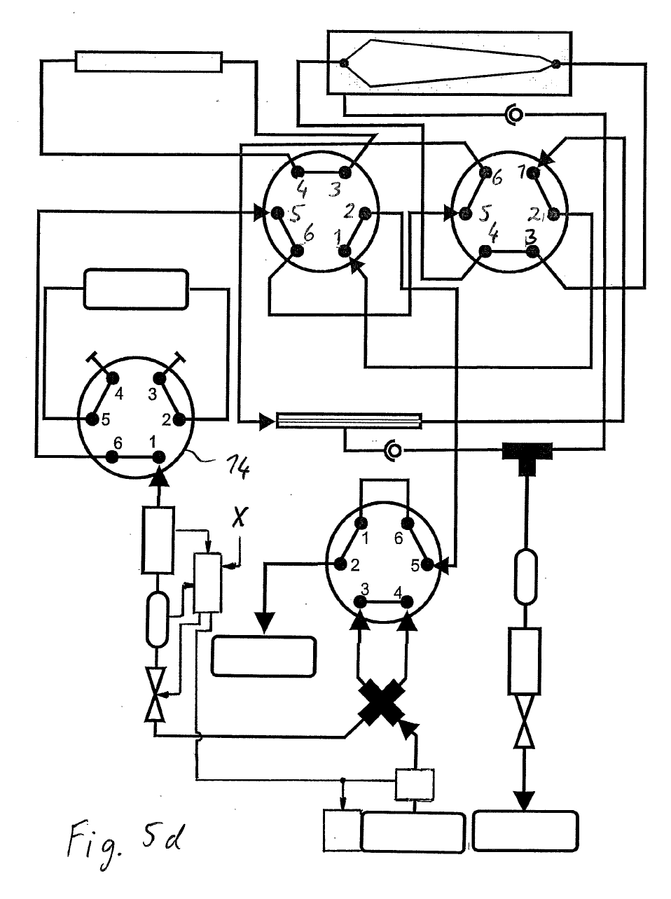

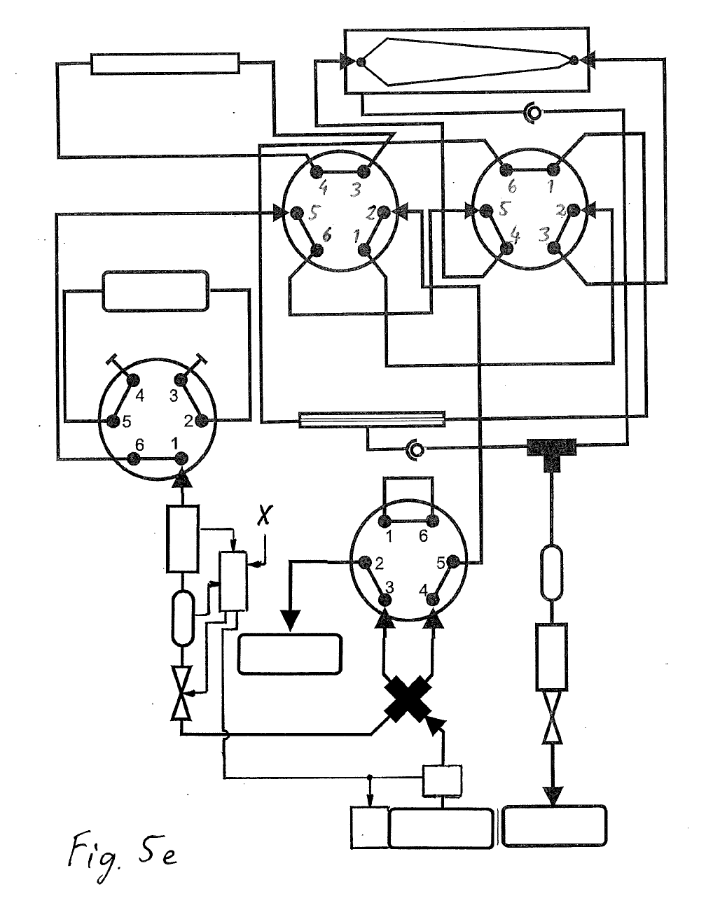

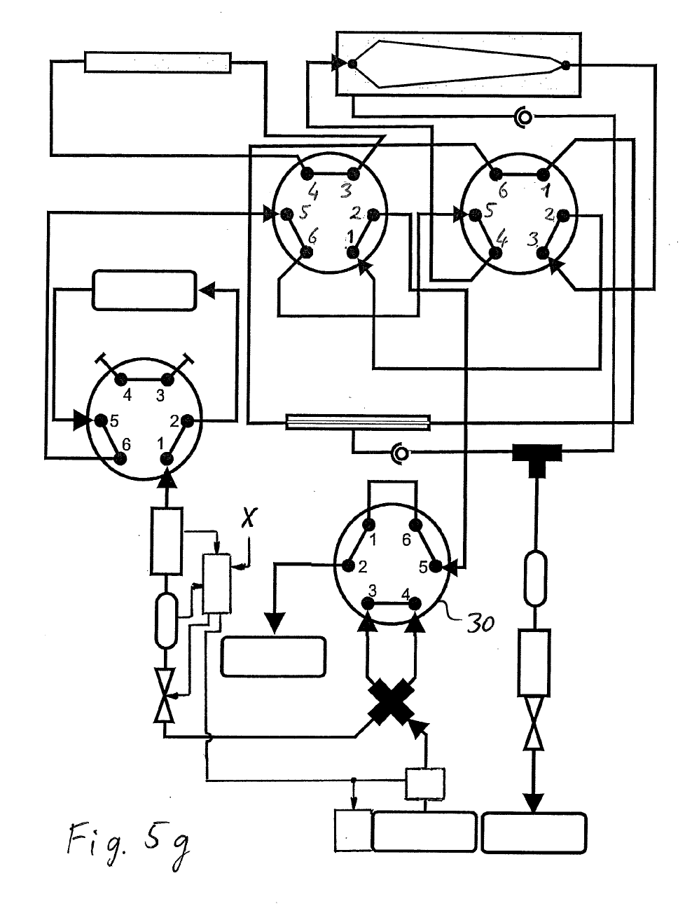

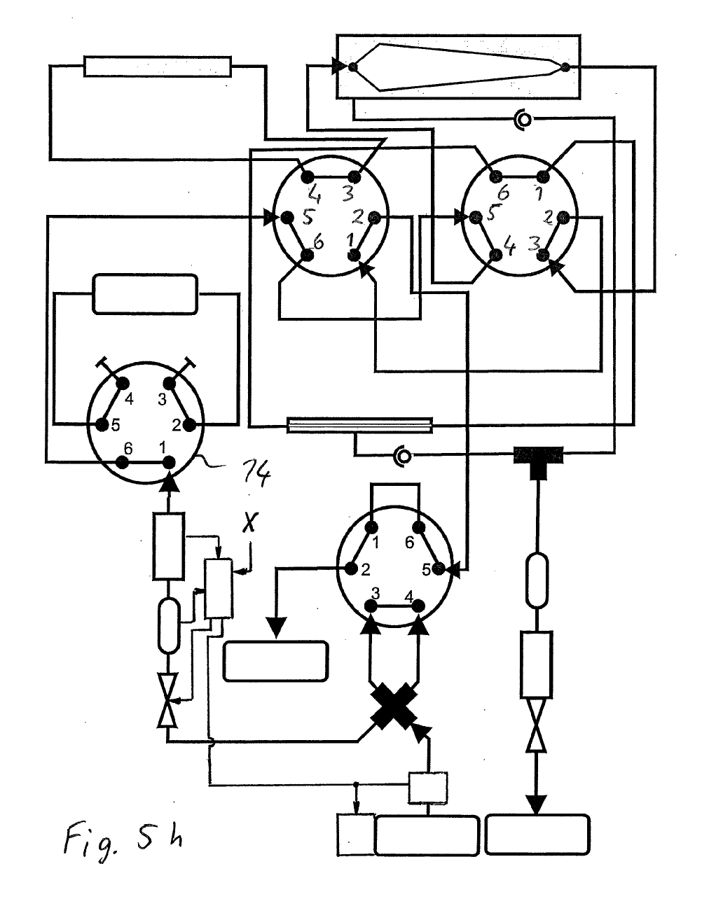

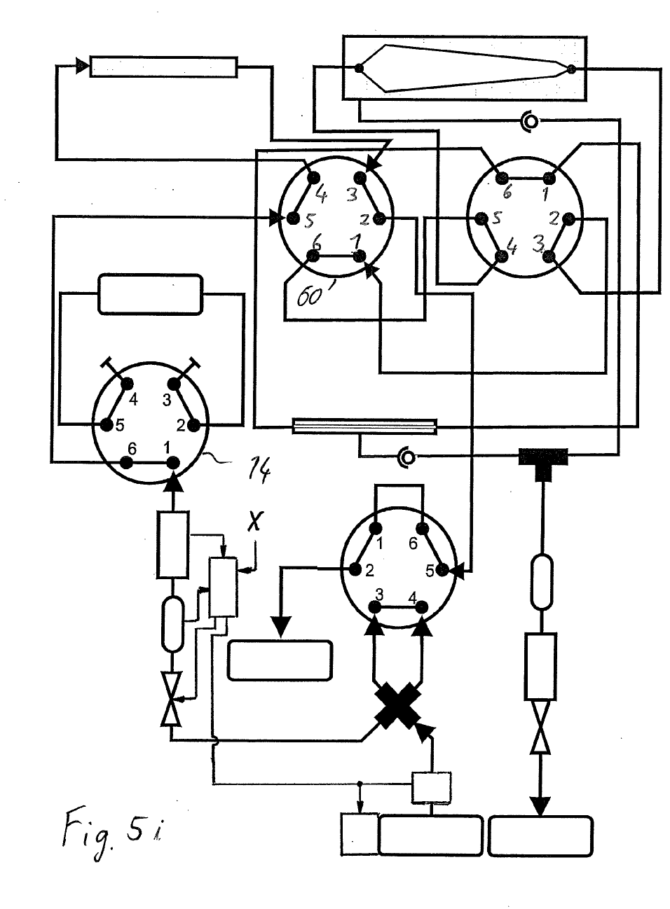

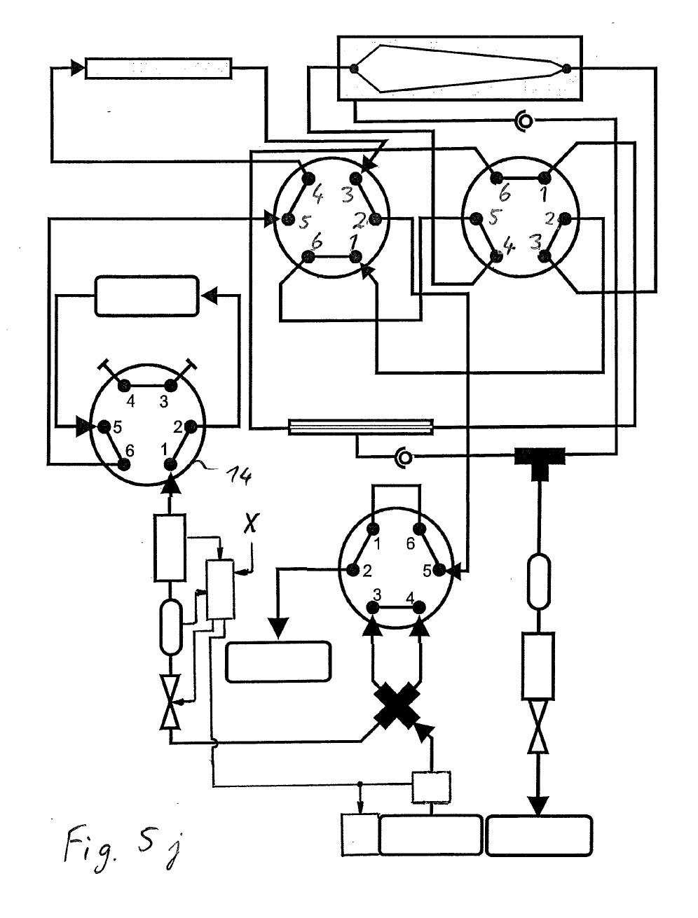

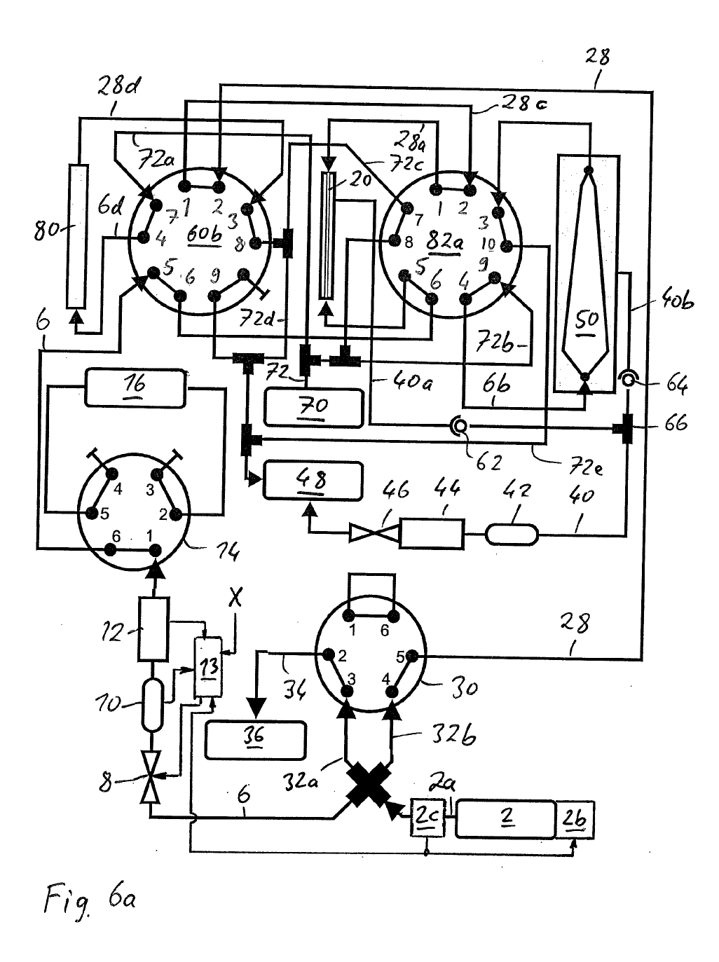

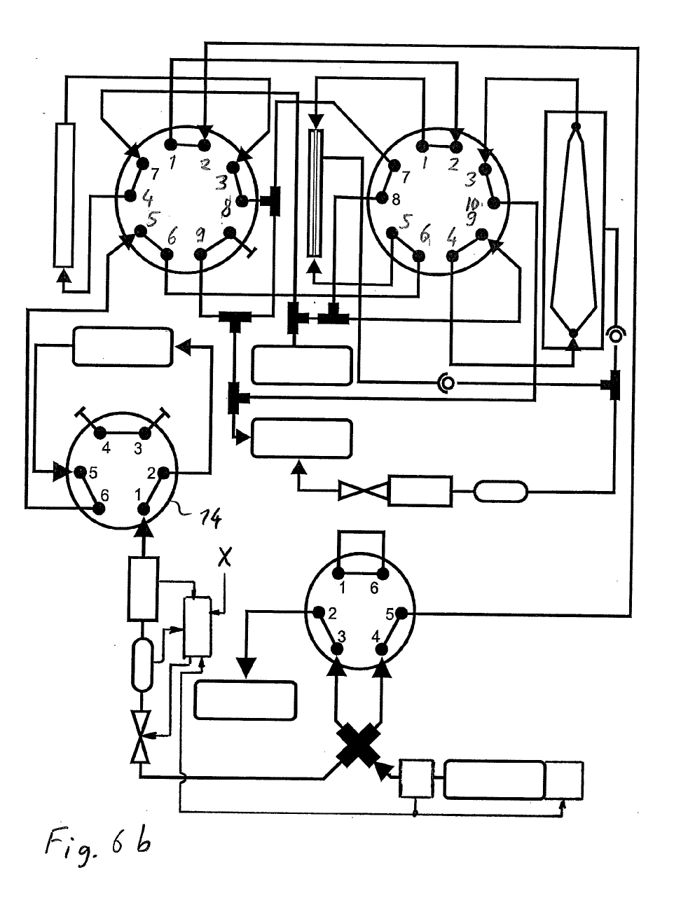

FIGS. 5a to 5j: a fifth embodiment of a device for field flux fractioning according to the present invention with a hollow fiber being used as the channel, a flat channel, and a chromatography-column in various operating states; and

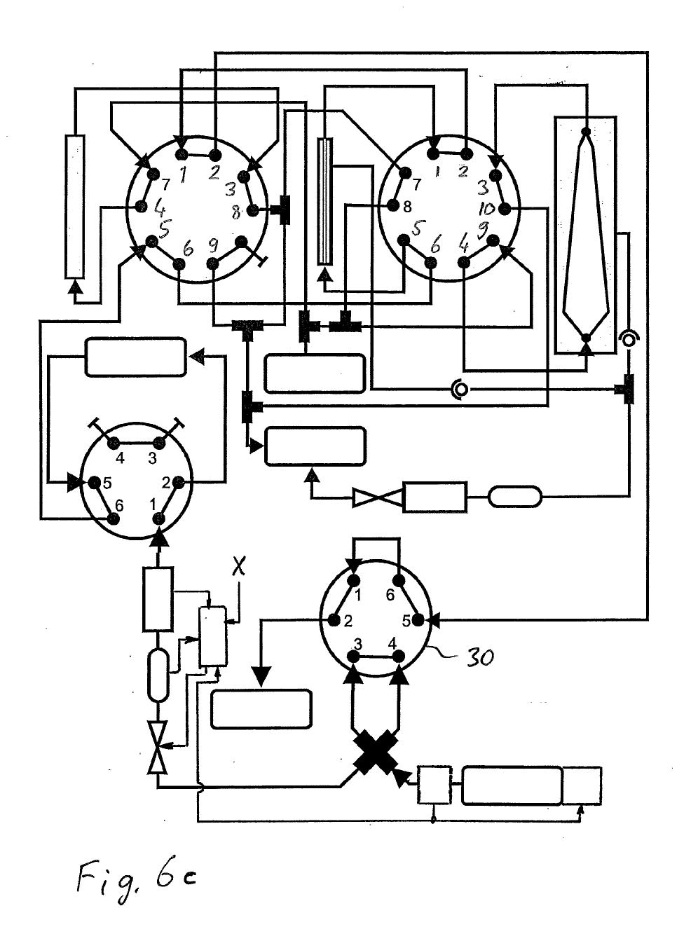

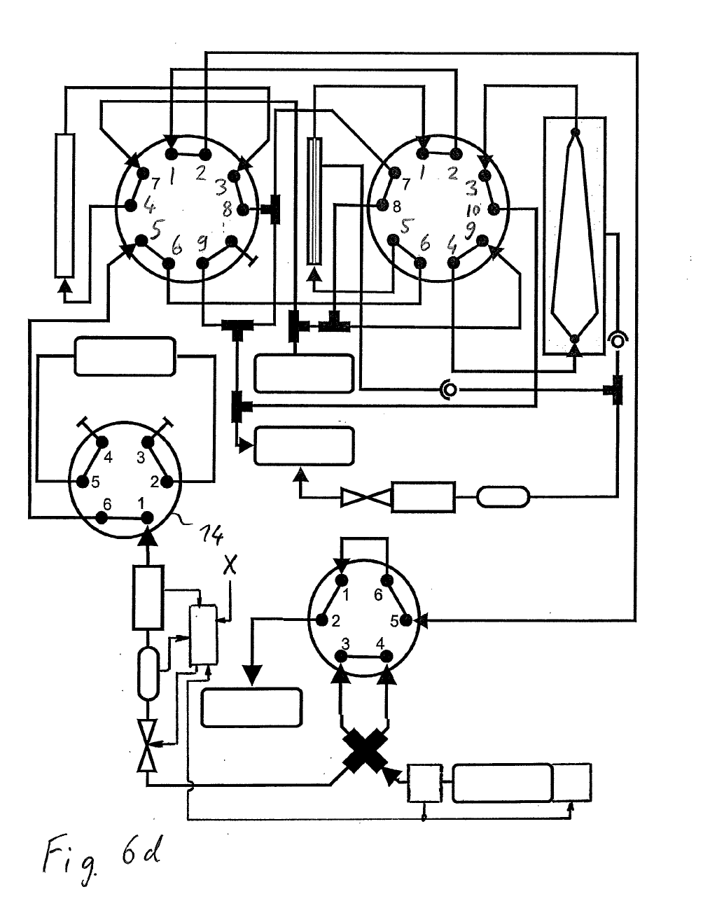

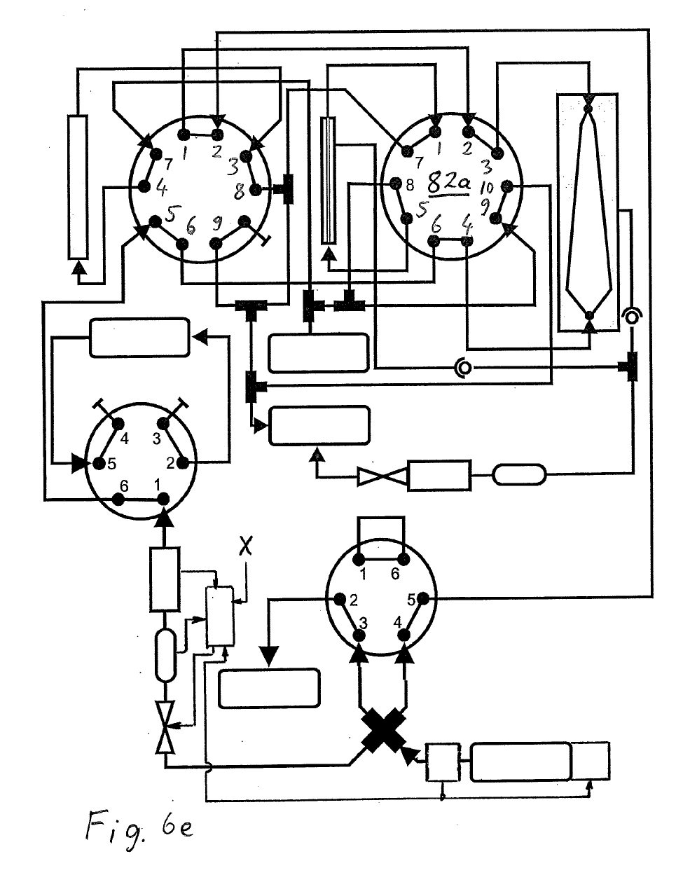

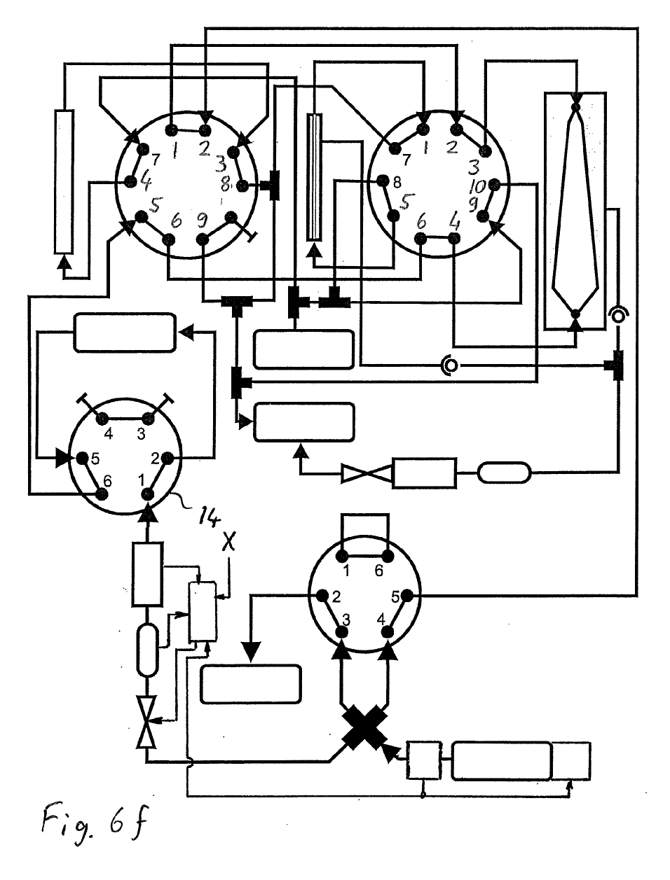

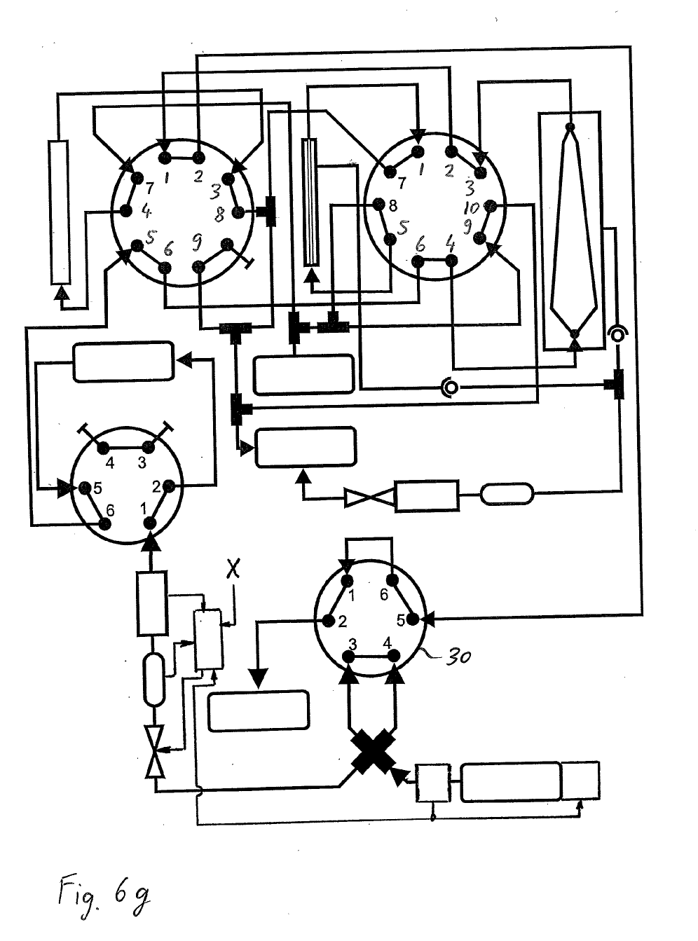

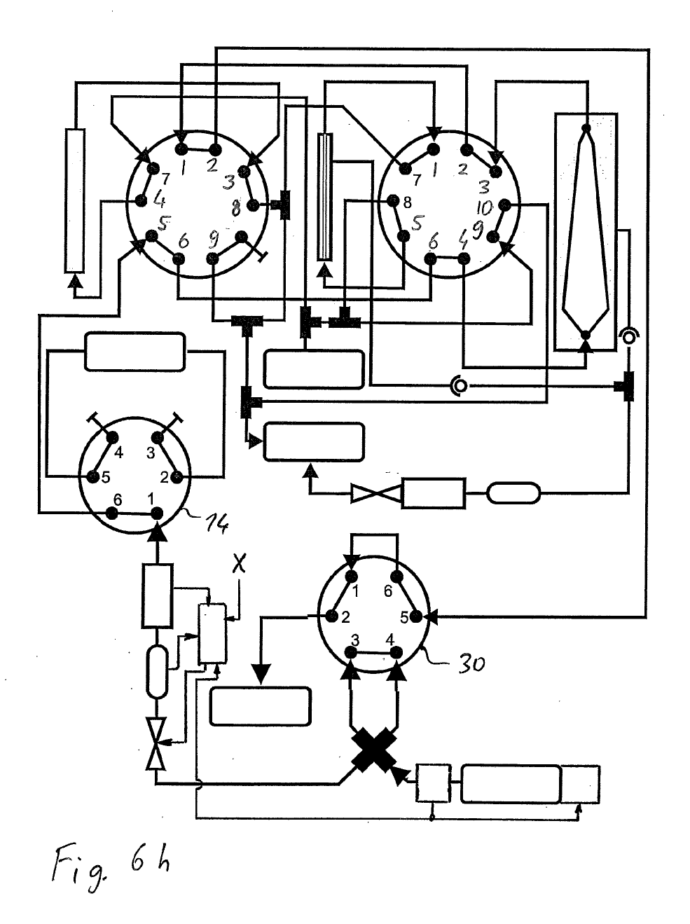

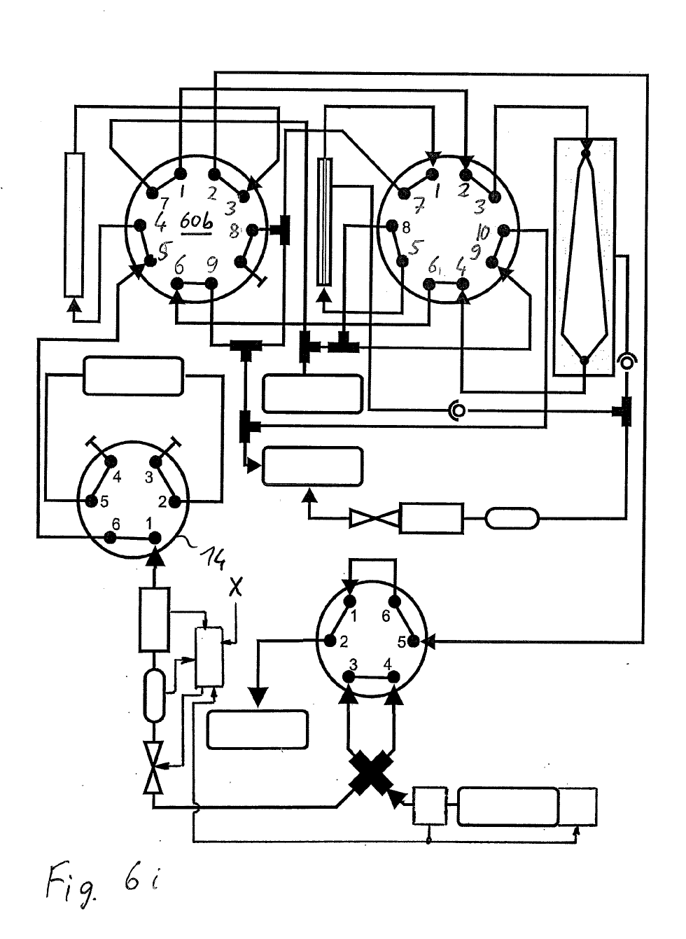

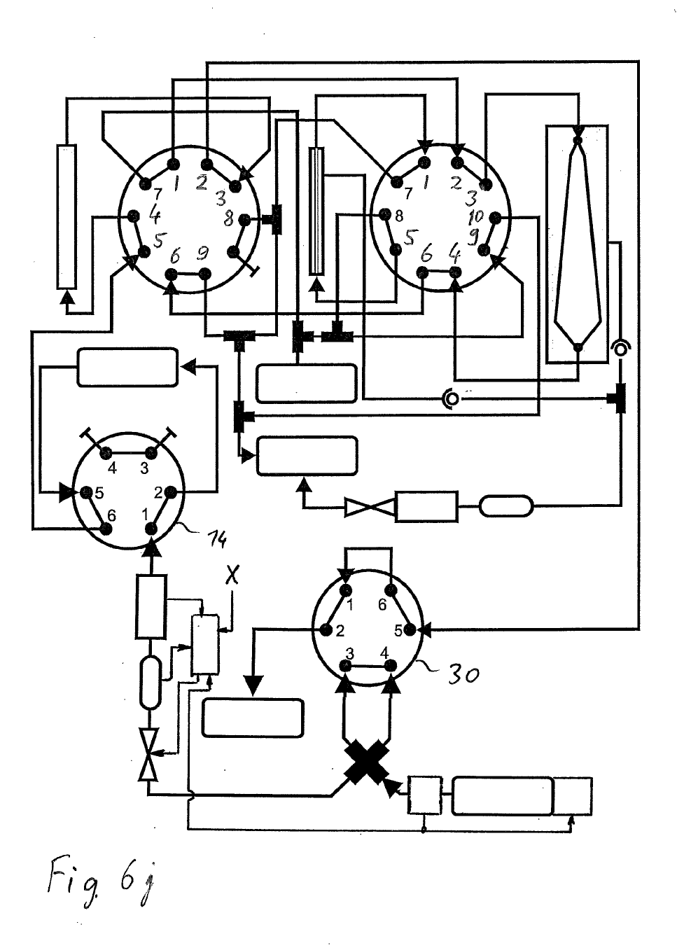

FIGS. 6a to 6j: a sixth embodiment of a device according to the present invention with a hollow fiber being used as the channel, a flat channel, a chromatography column, and a rinsing device.

FIGS. 1a to 1d show a first embodiment of a device to implement the method for field flux fractioning. Here, in FIG. 1a all essential components are marked with reference characters, while in FIGS. 1b to 1d, which show the first embodiment in different operating states, for reasons of better visibility only those components are marked with reference characters which are responsible for the respective operating state shown.

The device shown comprises a pump 2, which in the described exemplary embodiment is provided as the only source to convey carrier liquid. Accordingly this pump 2 manages the provision of the entire flow volume of carrier liquid required for the device. Usually, the pump 2 obtains the carrier liquid from a respective carrier liquid reservoir, which is not shown in the figures. The pump 2 is connected via its outlet 2a to a distributor 4, from which a first liquid path 6 forks off. In order to precisely adjust and/or dose the flow volume of the carrier liquid dispensed by the pump 2 to a certain reproducible value the amount conveyed by the pump 2 is appropriately controlled. For this purpose a control unit 2b is provided, which detects the flow volume of the carrier liquid dispensed by the pump 2 into the path to the distributor 4 and accordingly adjusts the conveyance of the pump 2 depending on a predetermined target value. The control unit 2b shown in FIGS. 1a to 1d schematically as a block may preferably form a common structural unit with the pump 2 or be integrated in the pump 2; in the latter case the pump 2 then represents a controlled pump with very precise options for dosing, as already available in the market.

In the first liquid path 6 a preferably electronically controlled needle valve 8 is switched, by which, when changing its cross-sectional opening, an adjustment of the flow rate and thus the flow volume of the carrier liquid through the first liquid path 6 can occur. As an alternative to the above-mentioned needle valve 8 entirely different types of valves may be used in general, and the valve may in principle also be adjusted manually. Instead of a magnetic valve, for example a needle valve allows a more precise adjustment, though, particularly in relatively small flow volumes. A pressure sensor 10 is provided downstream in reference to the needle valve 8. Again downstream in reference to said pressure sensor 10 in the first liquid path 6 a flow meter 12 is provided, which detects the flow volume in volume/time unit. The needle valve 8 and the flow meter 12 jointly form a flow control for the carrier liquid in the first liquid path 6. The pressure sensor 10 is however provided to detect a potential over-pressure and thus it is intended as a safety measure against excess pressure in order to prevent any damage in the device caused by excess pressure. The measurements provided by the pressure sensor 10 and the flow meter 12 are transmitted to a control 13, which controls the needle valve 8. In addition to the measurements performed by the pressure sensor 10 and the flow meter 12 in the exemplary embodiment shown also the entire flow volume of the carrier liquid conveyed by the pump 2 is detected, and for this purpose a respective flow volume sensor 2c is provided in the path leading from the pump 2 to the distributor 4. Accordingly, depending on the measurements of the flow volume sensor 2c, the pressure sensor 10, and the flow meter 12 as well as further depending on the input of the target value X for the desired distribution ratio the control 13 causes a respective adjustment of the opening cross-section in the needle valve 8. In normal operation (without excess pressure) here the flow volume of the carrier liquid in the first liquid path 6 is controlled to a predetermined target value X by the control 13 via the flow volume sensor 2c, the needle valve 8, and the flow volume meter 12. Here, it shall additionally be mentioned that the measurement of the flow volume sensor 2c at the outlet 2a of the pump 2 can additionally be used by the control unit 2b, acting upon the pump 2, so that the flow volume sensor 2c is also connected to the control unit 2b, as discernible from FIGS. 1a to 1d as well.

Downstream in reference to the flow meter 12 a switching means 14 is provided in the first liquid path 6, serving to switch a sample injection device 16 in the first liquid path 6 in order to insert a sample into the carrier liquid located in the first liquid path 6, comprising at least two, usually however considerably more (if applicable up to several thousand) sample components to be analyzed. The sample components to be analyzed are small parts which particularly represent particles, macro-molecules, or molecules. The switching means 14 may assume two switch positions. As shown in FIGS. 1a and 1d, in the first switch position in the switching means the contact “1”, with the upstream section of the first liquid path 6 being connected, is coupled to the contact “6”, with here the part of the liquid path 6 being connected leading further downstream, while the sample injection device 16 coupled to the contacts “2” and “5” is separated from the first liquid path 6 so that the carrier liquid also flows through the first liquid path 6 and the switching means 14 past the deactivated sample injection device 16. In the second switch position shown in FIGS. 1b and 1c, in the switching means 14 the contacts “1” and “6” are interrupted and the contacts “1” and “2” as well as “5” and “6” are respectively connected to each other, so that in this second switch position the carrier liquid dispensed from the flow meter 12 and thus the section of the first liquid path 6 located upstream is guided through the sample injection device 16 in order to insert samples into the carrier liquid. Preferably the switching means 14 is embodied as a manually operated and/or motorized rotary switch, as also discernible from the figures in a schematic fashion.

In the exemplary embodiment according to FIG. 1 the first liquid path 6 leads from the contact “6” of the switching means 14 directly to a separating channel, here made from a hollow fiber 20. At its first end 20a the hollow fiber 20 comprises a first connection 22, with a first liquid path 6 leading thereto, and a second connection 24 at its opposite second end 20. As further schematically discernible from FIG. 1 the hollow fiber 20 is located in a tube 26 and is surrounded thereby at a distance.

A second liquid path 28 leads from the second connection 24 of the hollow fiber 20 to the contact “2” of a switching means 30, with the distributor 4 being connected at its contacts “3” and “4” via connection lines 32a, 32b. Further, via a connection line 34 a detector and/or sensor 36 is connected to the contact “5” of the switching means 30. The switching means 30 can optionally be switched to a first switch position or a second switch position. During focusing the switching means 30 is in its first switch position, as shown in FIGS. 1a and 1b. In the first switch position the contacts “2” and “3” are connected in the switching means 30, with this way the pump 2 being coupled via the distributor 4 and the second liquid path 28 to the second connection 24 of the hollow fiber 20. Further, in the first switch position the contacts “4” and “5” are connected to each other, causing the pump 2 to be coupled via the distributor 4 and the connection line 34 additionally to the sensor 36. This way in the first switch position of the switching means 30 the pump 2 conveys the carrier liquid not only through the first liquid path 6 into the first connection 22 of the hollow fiber 22 but additionally also carrier liquid via the second liquid path 28 into the second connection 24 of the hollow fiber 20 in order to generate opposite flows in the hollow fiber 20 during focusing. Further, the pump 2 additionally conveys in the first switch position of the switching means 30 some carrier liquid into the sensor 36 in order to rinse it and thus to reduce the risk of sedimentation. Due to the fact that the sensor 36 used for the present device is sensitive for pressure and flow and the change of the flow in the sensor 36, here baseline drifts would develop at the sensor 36, which only slowly subside over time and cause an undesired drift of the baseline of chromatograms. In this context a complete interruption of the flow by the sensor 36 is particularly critical. The above-mentioned disadvantageous observations can be prevented by way of rinsing. Preferably the switching means 30 is also embodied as a manually operated and/or motorized rotary switch, as schematically discernible from the illustration in the figures.

Due to the fact that the jacket and/or the wall of the hollow fiber 20 is porous a portion of the carrier liquid located inside the hollow fiber 20 exits into a compartment 38 formed between the hollow fiber 20 and the tube 26 and is drained via a third liquid path 40 connected to the compartment 38. A pressure sensor 42 is provided in the third liquid path 40, with a flow meter 44 being arranged downstream thereof. Also downstream in reference to the flow meter 44 a preferably electronically controlled magnetic valve 46 is arranged in the flow path 40, by which via the change of its open cross-section the flow rate and thus the flow volume (volume/time unit) of the carrier liquid can be appropriately adjusted. In the liquid path 40 the pressure sensor 42 measures the pressure caused by the backpressure effects depending on the level of permeability of the wall of the hollow fiber 20. Here, the pressure sensor 42 (similar to the pressure sensor 10) assumes a safety function against excess pressure. The measurements yielded by the pressure sensor 42 and the flow meter 44 are transmitted to a control, not shown, which causes an appropriate adjustment of the open cross-section in the magnetic valve 46 depending on said measurements. This way, the flow volume and/or drainage amount of the carrier liquid is controlled in the third liquid path 40 to the predetermined target value. In the default condition, thus when no excess pressure is applied in the third liquid path 40, the control of the flow volume is determined by the flow meter 44 and the magnetic valve 46. Instead of a magnetic valve all other types of valves can be used, in general, and the valve may also be implemented in a manually adjusted fashion, in principle. The magnetic valve 46 mentioned is therefore preferred because it is particularly suitable for the control of comparatively large flow volumes. As further discernible from the figures the portion of the carrier liquid deviated from the compartment 38 between the hollow fiber 20 and the surrounding tube 26 is guided through the third liquid path 40 into a refuse reservoir 48 which is located downstream in reference to the needle valve 46.

For the rest, the flow meter 12 may also be used temporarily, as needed, for a precise measuring of the conveyance of the pump 2 and thus the entire flow volume of the carrier liquid dispensed by the pump 2 overall. For this temporary measuring operation the entire carrier liquid conveyed by the pump 2 needs to be guided exclusively through the first liquid path 6. Here, it must be ensured that any deviation into the second liquid path 28 and the connection line 34 to the sensor 36 is prevented and thus in this case the second liquid path 28 and the connection line 34 are closed. Such a temporary operating state can be particularly realized such that a third switch position is provided for the switching means 30, not shown in the figures, in which the connections to the second liquid path 28 and in the connection line 34 are equally blocked, or valves, not shown in the figures either, are optionally used to close the second liquid path 28 and the connection line 34. Using such a temporary measuring operation particularly deviations can be detected, which occur for example due to pressure differences in the section of the first liquid path 6 extending from the pump 2 to the flow meter 12 and/or which are the result of wear and tear in the pump 2. If such changes are detected a correction factor may be determined and considered appropriately for the adjustment in the control 13 in order to appropriately compensate such changes by way of calculation. After the conclusion of such a temporary measuring operation then normal operation is resumed.

Here, it shall be mentioned that the liquid paths 6, 28, and 40 are preferably embodied as pipelines or hoses.

In the following the device shown in FIGS. 1a to 1d is additionally explained based on FIGS. 1aa to 1dd. Here, in FIGS. 1aa and 1ba only one section of the hollow fiber 20 is shown in the area of its first end 20a and adjacent to a first section 22 schematically in a perspective “transparent” view, while the FIGS. 1bb and 1bc show a section of the hollow fiber 20 in the area of a relaxation point R in the longitudinal cross-section, and in FIG. 1da a longitudinal cross-section is shown of a section of the hollow fiber 20 in the area of its first end 20a and the first connection 22, while FIG. 1db shows a section of the hollow fiber 20 in the longitudinal cross-section, and FIG. 1dc in a longitudinal cross-section a part of the hollow fiber 20 in the area of its second end 20b and adjacent to the second connection 24, while FIG. 1dd shows a measuring curve generated by the sensor 36.

FIGS. 1a and 1aa show a first operating state of the device according to the first embodiment during focusing at a point of time at which no sample has been injected into the carrier liquid, so that the sample injection device 16 is separated from the first liquid path 6. Accordingly the switching means 14 is in the first switch position. Further it is discernible from FIG. 1a that the switching means 30 is also in its first switch position; this remains the case as long as focusing is ongoing. Thus, in the operating state shown in FIG. 1a, which serves for equilibration of the sensitive flux balance, pure carrier liquid is pumped, which therefore not yet contains any sample, in the direction of the arrows A and B opposite each other (FIG. 1aa) through the two connections 22, 24 at both ends 20a, 20b of the hollow fiber 20 into the hollow space. Here, two oppositely aligned flow fronts develop, which meet within the hollow space of the hollow fiber 20 at a certain position, thus forming the relaxation point R. The continuous flux lines shown in FIG. 1aa represent the longitudinal flux lines, which meet at the relaxation point R. Subsequently the carrier liquid fed through the two connections 22, 24 into the hollow fiber 20 discharge through the porous wall 20c of the hollow fiber 20 out of it and into the compartment 38 limited by the exterior located tube 26 and is drained in the direction of the arrow C (FIG. 1aa) via the third liquid path 40. This lateral flow or cross flow shown in narrow dot-dash lines in FIG. 1aa is supplied entirely from the channel flow and exits the hollow fiber 20 at each point perpendicular in reference to the longitudinal axis thereof through a wall 20c embodied as a membrane. In the volume at the other side, formed by the compartment 38, the partial flows of the lateral flow merge and, as already mentioned, they are drained via the third liquid path 40. At the relaxation point R, where the two oppositely aligned flow fronts meet, a so-called neutral zone develops, in which the axial flow, thus the flow in the longitudinal direction of the hollow fiber 20, is zero, which however forms a lateral flow in the direction to the porous wall of the hollow fiber 20. Due to the fact that the hollow fiber 20 is essentially annular in its cross-section and its wall 20c (FIG. 1aa) is porous essentially over its entire circumference when using a hollow fiber as the channel then an essentially fanned radial lateral flow forms. This neutral zone is used during the following elution as the starting point for the sample.

By moving the switching means 14 into the second switch position according to FIG. 1b the device is brought from the first operating state into a second operating state, in which the sample injection device 16 is connected to the first liquid path 6, dispensing samples stored therein, into the carrier liquid flowing through the first liquid path 6. Additionally, here reference is made to FIGS. 1ba, 1bb, and 1bc. The carrier liquid transports the sample from the sample injection device 16 through the section of the first liquid path 6 located downstream thereof and the first connection 22 into the hollow fiber 20 until it has reached the relaxation point R in the hollow space of the hollow fiber 20 and thus the neutral zone. The position of the relaxation point R (FIG. 1ba) and/or the neutral zone is determined by the ratio of the flow rate of the carrier liquid through the first liquid path 6 and the first connection 22 on the one side and by the second liquid path 28 and the second connection 24 on the other side. Thus, the distribution ratio of the flow volume of the carrier liquid overall conveyed by the pump 2 to the first liquid path 6 and to the second liquid path 28 represents a reliable parameter, from which the relative position of the relaxation point and/or the neutral zone can be determined. When the length of the channel (formed by the hollow fiber 20 in the first embodiment according to FIGS. 1a to 1d) is known (distance between the first connection and the second connection, then the path length traveled by the sample components during the following elution up to the second connection in the cannel can be determined and thus also the absolute location of the relaxation point and/or the neutral zone.

When the amount conveyed by the pump 2 is fixed predetermined and/or can be adjusted in a fixed manner the distribution ratio can be adjusted and/or controlled by adjusting and/or controlling the flow rate and/or the flow volume of the portion of the carrier liquid guided through the first liquid path 6 to the desired value. This purpose is served by the components 8 and 12 provided in the first liquid path 6 and described above. Thus, the ratio of the volume flows pumped opposite through the connections 22, 24 into the hollow fiber 20 depends on the quantity of carrier liquid branched off by the distributor 4 into the first liquid path 6.

This can be illustrated in the following example: The pump 2 shows a conveyance capacity of 4 ml/min. This conveyance capacity is constant. The total of the flow volume is determined by the first liquid path 6 and the flow volume through the second liquid path 28 by the flow volume through the third liquid path 40. As described above, the flow volume through the third flow path 40 is adjusted and/or controlled by the magnetic valve 46 in cooperation with the flow meter 44. When the magnetic valve 46 is adjusted such that less flow volume is drained via the third liquid path 40 than the volume conveyed by the pump 2 this automatically leads to the access portion being guided through the connection line 34 to the sensor 36. For example, if the flow volume in the third liquid path 40 is adjusted to 3 ml/min by the magnetic valve 46 here from the volume provided by the pump 2 totaling 4 ml/min a portion of the carrier liquid amounting to 1 ml/min is conveyed to the sensor 36 in order to rinse it. Accordingly, in the present example a conveyed volume totaling 3 ml/min remains for the first liquid path 6 and the second liquid path 28. The flow rate and/or the volume conveyed or flown of the portion of carrier liquid guided through the first liquid path 6 is adjusted and/or controlled to 0.3 ml/min in the present example so that the portion of carrier liquid conveyed through the first liquid path 6 enters the hollow fiber 20 with a flow rate of 0.3 ml/min through the first connection 22. Due to the fact that in the present example from the total volume of 4 ml/min conveyed by the pump 2, 1 ml/min is branched off during focusing via the line 34 to the sensor 36 and 0.3 ml/min to the first liquid path 6 here 2.7 ml/min remains for the second liquid path 28, so that the portion of carrier liquid guided through the second liquid path 28 enters the hollow fiber 20 with a flow rate of 2.7 ml/min through the second connection 24. Thus the distribution ratio amounts to 0.3:2.7=1:9 so that the relaxation point and/or the neutral zone are formed at a point which is located at a distance from the first connection 22 of 10% of the overall length of the channel formed by the hollow fiber. If in the above-stated example the length of the channel from the first connection 22 and the second connection 24 amounts to e.g. 20 cm it can be assumed that the position of the neutral zone is located at a distance of 2 cm from the first connection 22 and/or at a distance of 18 cm from the second connection 24.

The carrier liquid is entirely drained from the hollow fiber 20 via the compartment 38 into the third liquid path 40. Here, the flow rate of the drained carrier liquid amounts in the third liquid path 40 to 3 ml/min according to the total of the flow rates entering through the two connections 22, 24 into the hollow fiber 20.

As discernible schematically particularly from FIG. 1ba the lateral flow generates a force field acting outwardly in the direction of the wall 20c of the hollow fiber 20, essential for the method in question. The simultaneous forward motion by the channel flow according to the continuous flux lines in the direction of the arrows A and B conveys the particles P in the radial direction away from the center in the direction of the wall 20c, impermeable for the particles but permeable for the liquid.

When arriving here at the relaxation pint R in the neutral zone, also called focal zone, the particles cannot leave this zone independently via diffusion because the path towards the front and the back is essentially blocked by influx of additional carrier liquid from the front and the back according to the oppositely aligned arrows A and B. This status is sketched in FIG. 1bb. Further, the particles P shown here schematically cannot reach the neighboring cross flow volume, either, due to the particle size, of the membrane-like wall 20c out of the hollow fiber 20 into the compartment 38. Each particle P is therefore subject to an equilibrium between the driving force due to diffusion in the direction of the central axis of the hollow fiber 20 and the radially outwardly flowing lateral flow and/or cross-flow, while the forces compensate each other by the flows from the front and the back in the direction towards the arrows A and B over the width of the neutral zone at the relaxation point R.

The demixing of the particles and simultaneously the concentration thereof is based on the particles with a smaller diameter moving faster due to diffusion than the comparatively larger particles. As discernible from FIG. 1bc to this regard, here the smaller particles P₁ concentrate at a greater average distance from the wall 20c while the larger particles P₂ show an average position in the proximity of the wall 20c and thus at a lower average distance therefrom. Accordingly, initially the unsorted, anisotropic distribution of the particles P according to FIG. 1bb during focusing transfers into a local, isotropic alignment according to FIG. 1bc.

After the sample (coming) from the sample injection device 16 has reached the relaxation point and/or the neutral zone inside the hollow fiber 20, the time required here can also be called injection interval, and the sample components have respectively separated from each other and positioned in the carrier liquid and thus the relaxation is concluded, the second operating state is converted into a third operating state and thus changed from focusing to elution. This occurs by switching the switching means 30 into the second switch position, as shown in a comparison of FIGS. 1a and 1b, illustrating the operating state during focusing, as discernible from FIGS. 1c and 1d. While the third operating state shown in FIG. 1 the sample injection device 16 is still switched on, FIG. 1d shows a subsequent fourth operating state in which the sample injection device 16 is switched off again, after the switching means 14 has once more been brought into the first switching state.

As further discernible from FIGS. 1c and 1d during the elution the pump 2 only supplies the first liquid path 6 with carrier liquid. As here particularly discernible in FIGS. 1da, 1db, and 1dc, during the elution the hollow fiber 20 is therefore only flown through with carrier liquid in one direction according to the arrow A. Due to the fact that the molecules of the liquid are subjected to increased friction in the area of the wall 20c the flow rate is not constant over the cross-section of the hollow fiber 20 but parabolic, which is indicated by the reference character “X” in FIGS. 1da and 1db. This means for the diffuse layers inside the hollow fiber 20 that they are flown through by flux lines with different flow rates. The smaller particles P₁ located farther away from the wall 20c are therefore moved faster than the larger particles P₂ located adjacent to the wall 20c, as discernible in a comparison of FIG. 1db with FIG. 1da. On the path from the relaxation point R in the direction towards the outlet 24 here successively the distance increases between the smaller particles P₁ and the larger particles P₂ in the longitudinal direction 20 and/or in the direction of flow according to the arrow A, which is once more discernible from a comparison of FIGS. 1dc and 1db. The lateral flow, not marked in FIGS. 1da, 1db, and 1dc, remains switched on during the entire time and during focusing it shows a layer-like orientation by the equilibrium acting upon the particles P₁, P₂.

Towards the end of elution and thus towards the end of the fourth operating state the particles P₁ and P₂ are now separated from each other as far as possible. They reach the detector and/or sensor 36 via the second outlet 24, the second liquid path 28, the second switching means 30, and via the connection line 34. Unlike in column chromatography the smaller particles P₁ reach the sensor 36 prior to the larger particles P₂ and here generate a respective signal, as discernible when comparing FIG. 1dd with FIG. 1dc.

After one run the hollow fiber 20 is briefly rinsed with pure fluent and/or pure carrier liquid before a new separation can start.

At this point it shall be mentioned for reasons of completeness that the porous wall of the hollow fiber 20 is permeable for the carrier liquid, however not for the sample components. For additional details in this context, particularly regarding the phenomenon of lateral forces, and to avoid repetitions reference is made to the above-stated explanations, particularly in the introduction of the description.

A second embodiment is shown in FIGS. 2a to 2d, which differs from the explanations made according to FIGS. 1a to 1d only such that a flat channel 50 is used instead of a hollow fiber as the separating channel. Here, all essential components are marked with reference characters in FIG. 2a, while in FIGS. 2b to 2d, which show the second embodiment in different operating states, for reasons of better clarity only those components are marked with reference characters which are relevant for the change of the operating state in reference to the operating state shown in the respectively prior figure.

The flat channel 50, which represents a design known per se, shows a first connection 52 at its one end 50a coupled to the first liquid path 6 and a second connection 54 at its second end 50b coupled to the second liquid path 28. As schematically indicated in FIGS. 2a to 2d the flat channel 50 comprises an oblong hollow body and shows in the exemplary embodiment a progression tapering in the direction of its longitudinal axis towards the second connection 54. The bottom of the flat channel 50 is embodied impermeable for the sample components and permeable for the carrier liquid so that the bottom forms a permeable section in the wall of the flat channel 50, which is not shown in the figures, though. As further indicated schematically in FIGS. 2a to 2d the flat channel 50 is located in a closed housing 56 so that a compartment 58 is formed between the wall of this housing 56 and the flat channel 50. In this compartment 58 a portion of the carrier liquid, discharged through the permeable bottom is collected. Similar to the compartment 38 in the first embodiment, the compartment 58 is connected to the third liquid path 40.

With regards to the other structural details and aspects the second embodiment is consistent with the first embodiment, so that to this regard, in order to avoid repetitions, reference is made to the description of the first embodiment. The same also applies accordingly with respect to FIGS. 1aa to 1dd and the description of the method disclosed above. Similar to the FIGS. 1a to 1d, in the FIGS. 2a and 2b the operating state of the device according to the second embodiment is shown during focusing with the sample injection device 16 (FIG. 2a) being shut off and the sample injection device 16 (FIG. 2b) being connected and in the FIGS. 2c and 2d the operating state of the device is shown during elution with the sample injection device 16 (FIG. 2c) being connected and the sample injection device (FIG. 2d) being shut off.

Here, it shall be mentioned that the connections 22, 24 of the hollow fiber 20 in the first embodiment and the connections 52, 54 of the flat channel 50 in the second embodiment may be embodied in a detachable fashion in order to allow an easier exchange of the hollow fiber 20 and/or the flat channel 50, if necessary.

Alternatively, in the very same device at least two channels with different embodiments may be provided, with one channel being connected for executing the field flux fractioning, and thus being activated. For this purpose another switching means must be provided, thus omitting any exchange of the channels by coupling and decoupling connections.

FIGS. 3a to 3h show a device in a third embodiment, comprising a combination of the first and second embodiments and thus showing both a hollow fiber 20 according to FIGS. 1a to 1d used as the channel as well as a flat channel 50 according to FIGS. 2a to 2d. Here, all essential components in FIG. 3a are marked with reference characters, while in FIGS. 3b to 3h, which show the third embodiment in different operating states, only those components are marked with reference characters for reasons of better visibility, which are relevant for the change of the operating state in reference to the respective operating state shown in the previous figure.

For an optional activation and deactivation of the hollow fiber 20 or the flat channel 50 another switching means 60 is provided, as schematically discernible from FIGS. 3a to 3h. This switching means 60 is simultaneously switched in the first liquid path 6 and the second liquid path 28 and shows two switch positions.

In the first switch position shown in FIGS. 3a to 3d the contact “5” connected to the first liquid path 6 is coupled to the contact “6”, with a line 6a leading to the first connection of the hollow fiber 20 being connected thereto. Further, in the first switch position of the switching means 60 the contact “1” connected via a line 28a to the second connection of the hollow fiber 20 is connected to the contact “2”, to which the second liquid path 28 is connected. This way, in the first switch position the hollow fiber 20 is connected and activated, while the flat channel 50 is separated from the remaining device and thus switched off, as discernible in FIGS. 3a to 3d.

When switching the switching means 60 from the first switch position into the second switch position shown in FIGS. 3e to 3h the hollow fiber 20 is switched off and thus deactivated and instead the flat channel 50 is connected and thus activated. For this purpose the contact “5” connected in the switching means 60 to the first liquid path 6 is connected to the contact “4”, which is connected to a line 6b leading to a first connection 52 of the flat channel 50. Additionally, in the second switch position in the switching means 60 the contact “2” connected to the second liquid path 28 is connected to the contact “3” to which a line 28b is connected via the second connection 54 of the flat channel 50.

The switching means 60 of the second embodiment may also preferably be embodied as a rotary switch, operated manually and/or motorized, as schematically shown in FIGS. 2a to 2d.

In order to guide off carrier liquid from the compartment between the hollow fiber 20 and the tube 26 surrounding it a first drainage line 40a is provided and for guiding off carrier liquid from the compartment 58 between the flat channel 50 and the housing 56 a second drainage line 40b. Both drainage lines 40a, 40b are connected via a switch 66 to the third liquid path 40. In order to avoid mutual influences a respective return valve 62 and/or 64 is provided in the drainage lines 40a, 40b.

Due to the fact that other design features and components of the third embodiment are consistent with the first embodiment and thus the same reference characters are used for identical components, in order to avoid repetitions reference is made to the previous description of the first embodiment.

FIGS. 3a to 3d show the use of the device according to the third embodiment with the hollow fiber 20, with in the FIGS. 3a and 3b the operating state of the device is shown during focusing with the sample injection device 16 (FIG. 3a) being disconnected and the sample injection device 16 (FIG. 3b) being connected and in the FIGS. 3c and 3d the operating state of the device during elution with the sample injection device 16 (FIG. 3c) being connected and the sample injection device (FIG. 3d) being disconnected. FIGS. 3e to 3h show the use of the device according to the third embodiment in the same sequence using the flat channel 50 while the hollow fiber 20 is disconnected.

FIGS. 4a to 4h shows the device for field flux fractioning according to a fourth embodiment, which comprises the components of the third embodiment according to FIGS. 3a to 3h, thus being equivalent to the third embodiment and differing therefrom such that additionally a rinsing device 70 is provided, which is additionally connected via the line 72 to the hollow fiber 20 and the flat channel 50 to a switching means 60a. Here, all essentially important components are marked with reference characters in FIG. 4a, while in FIGS. 4b to 4h, which show the fourth embodiment in different operating states, for better visibility only those components are marked with reference characters which are relevant for the change of the operating state in reference to the operating state of the respectively previously shown figure.

By the switching means 60a, which for the rest also show the same functions as the switching means 60 of the third embodiment, additionally a rinsing device 70 is connected to the respectively unused channel 20 and/or 50 in order to accordingly rinse the unused channel, which is therefore separated and not activated for executing the field flux fractioning. A preferably continuous rinsing shortens the time until operation and/or measuring readiness of the respective channel, because this way disturbing residue in the channel is removed after changing samples or any adherence of disturbing residue is prevented right from the start. Such disturbing components include, among other things, a so-called bacterial lawn, which can adhere to the interior wall of the channel particularly easily depending on the flow rate. Accordingly the switching means 60a differs from the switching means 60 of the third embodiment by the arrangement of four additional contacts. Here, the line 72 coming from the rinsing device 70 is connected to the contact “3”, which in the first switch position according to FIGS. 4a to 4d is connected to the contact “4”. Due to the fact that the contact “4” is connected via the line 6b to the first connection 52 of the flat channel 50 the rinsing liquid is guided from the rinsing device 70 through the flat channel 50, in the first switch position of the switching means 60a separated from the remaining device, from which the rinsing liquid is discharged via the second connection 54 and the line 28b connected thereto. Said line 28b is connected to the contact “8”, which is connected in the first switch position in the switching means 60a to the contact “7”, which in turn is connected to a drainage line 76 leading to the refuse reservoir 48. In the second switch position of the switching means 60a according to FIGS. 4e to 4h, in which the flat channel 50 is connected and the hollow fiber 20 is separated, the contacts “6” and “7” as well as “3” and “4” are each connected to each other, in the switching means 60a for rinsing the now unused hollow fiber 20, thus the rinsing liquid is conveyed from the rinsing device 70 through the line 28a into the hollow fiber 20 and from said hollow fiber 20 via the line 6a to the drainage line 76.

Here too, the switching means 60a of the fourth embodiment can be embodied preferably as a rotary switch, operated manually and/or motorized, as schematically shown in FIGS. 4a to 4h.

Due to the fact that with regards to additional structural details and components the fourth embodiment is consistent with the third embodiment and to this regard identical reference characters are used for identical components, reference is made to the above-stated description of the third embodiment.

With regards to the illustration of the different operating states the FIGS. 4a to 4h also show the same sequence and allocation as FIGS. 3a to 3h.

In FIGS. 5a to 5j the device is shown in a fifth embodiment, which shows the components of the third embodiment according to FIGS. 3a to 3h, thus to this extent they are equivalent to the third embodiment, however differing from the third embodiment such that in addition to the hollow fiber 20 and the flat channel 50 also a chromatography column 80 is provided, so that in this embodiment it can be selected between three channel variants. Here, in FIG. 5a all essential components are marked with reference characters, while in FIGS. 5b to 5j, which show the fifth embodiment in different operating states, for reasons of better visibility only those components are provided with reference characters, which are relevant for the change of the operating state in reference to the operating state shown in the respectively previous figure.

For this purpose, in addition to the switching means 60 already used in the third embodiment, another switching means 82 is provided. Both switching means 60 and 82 are each switchable between two switch positions. In the first switch position shown in FIGS. 5a to 5h the first switching means 60 establishes a connection between the first liquid path 6 and the second liquid path 28 on the one side and the second switching means 82 on the other side. Concretely, in the first switch position the contact “5” coupled in the switching means 60 to the first liquid path 6 is connected to the contact “6”, which is connected via a line 6c to the contact “5” of the switching means 82. Additionally, in the first switch position of the switching means 60 its contact “2” coupled to the second liquid path 28 is connected to the contact “1”, which is connected via a connection line 28c to the contact “2” of the switching means 82. In the first switch position of the switching means 82 shown in FIGS. 5a to 5d the contact “5” is connected to the contact “6”, which is coupled via the line 6a to the first connection of the hollow fiber 20, and the contact “2” to the contact “1”, which is coupled via the line 28a with the second connection of the hollow fiber 20. Thus by the switch position of the switching means 82 shown in FIGS. 5a to 5d the hollow fiber 20 is connected as an active channel and activated for the execution of field flux fractioning. When the switching means 82 is switched into the second switch position shown in FIGS. 5e to 5h the hollow fiber 20 is deactivated and instead the flat channel 50 is connected as the active channel and thus activated for the execution of field flux fractioning. Now the contacts “2” and “3” as well as “4” and “5” are respectively connected to each other such that the line 6b leading to the first connection 52 of the flat channel 50 is connected to the connection line 6c and thus to the second liquid path 28 via the first liquid path 6 as well as the line 28b connected to the second connection 54 of the flat channel 50 via the line 28c.

When independent from the switch position of the switching means 82 the switching means 60 is brought into the second switch position, as shown in FIGS. 5i and 5j, instead of the hollow fiber 20 and the flat channel 50 the chromatography column 80 is connected, by the line 6d leading to the chromatography column 80 being coupled via the contacts “4” and “5” then connected to each other in the switching means 60 to the first liquid path 6 and the line 28d connected to the other end of the chromatography column 80 via the contacts “2” and “3” then connected to each other to the second liquid path 28. Due to the fact that for the chromatography columns no focusing mode is given the FIGS. 5i and 5j show the use of the device according to the fifth embodiment using the chromatography column 80 only during elution, namely optionally with the sample injection device (FIG. 5i) being switched off and the sample injection device (FIG. 5j) being connected.

Similar to the switching means 60 the switching means 82 of the fifth embodiment may also be preferably embodied as a rotary switch, operated manually and/or automated, as schematically shown in FIGS. 5a to 5j.

For the rest, it is alternatively also possible to combine the two switching means 60 and 62 to form a joint switching means, which is not shown in the figures, though.

Due to the fact that with regards to further structural details and components the fifth embodiment is consistent with the third embodiment and thus the same reference characters are used for identical components here, in order to avoid repetitions, reference is made to the previous description of the third embodiment.

The FIGS. 5a to 5d show the use of the device according to the fifth embodiment with the hollow fiber 20, with in FIGS. 5a and 5b the operating state of the device is shown during focusing with the sample injection device 16 (FIG. 5a) being switched off and with the sample injection device 16 (FIG. 5b) being connected and in FIGS. 5c and 5d the operating state of the device during elution with the sample injection device 16 (FIG. 5c) being connected and the sample injection device (FIG. 5d) being switched off, while the flat channel 50 and the chromatography column 80 being disconnected. The FIGS. 5e to 5h show the use of the device according to the fifth embodiment in the same sequence using the flat channel 50, while the hollow fiber 20 and the chromatography column 80 are switched off. FIGS. 5i and 5j in turn show the operation of the device according to the fifth embodiment using the chromatography column 80 only during elution, while the hollow fiber 20 and the flat channel 50 are switched off.

FIGS. 6a to 6j show the device in a sixth embodiment forming a combination of the fourth and fifth embodiments, or in other words, being equivalent to the fifth embodiment according to FIGS. 5a to 5j and additionally including the rinsing device 70 of the fourth embodiment according to FIGS. 4a to 4h, which is connected via the line 72 and hereby via a branching not marked in greater detail to lines 72a, 72b, 72c, and 72d additionally to the hollow fiber 20, the flat channel 50, and the chromatography column 80 to a switching means 60b as well as further an additional switching means 82a. Here, all essential components are marked with reference characters in FIG. 6a, while in FIGS. 6b to 6j showing the sixth embodiment in different operating states for better visibility only those component are marked with reference characters, which are relevant for the change of the operating state in reference to the operating state of the previous figure.

By the switching means 60b, 82a, which for the rest show the same functions as the switching means 60, 82 of the fifth embodiment, additionally the rinsing device 70 is connected to the respectively unused channel 20 and/or 50 or the unused chromatography column 80 in order to rinse and thus clean the unused channel and/or the unused chromatography column, which is therefore separated and thus not activated to execute the field flux fractioning. Accordingly the switching means 60b, 82a differ from the respective switching means 60, 82 of the fifth embodiment by the arrangement of additional contacts.

FIGS. 6a to 6d show the switching means 60b, 82a in their respective first switch position. The combination of the first switch position of the switching means 60b with the first switch position of the switching means 82a leads to the hollow fiber 20 being connected and thus being activated to perform the field flux fractioning, while the flat channel 50 and the chromatography column 80 not being activated for executing the field flux fractioning and thus being switched off and unused, however instead thereof they are connected to the rinsing device 70 in order to be rinsed thereby.

FIGS. 6e to 6h show the switching means 60b again in its first switch position, however the switching means 82a being in its second switch position. The combination of the first switch position of the switching means 60b with the second switch position of the switching means 82a leads to now the flat channel 50 being connected to execute the field flux fractioning and thus being activated, while the hollow fiber 20 and the chromatography column 80 are not activated to execute the field flux fractioning, but are switched off and thus unused, however instead thereof connected to the rinsing device 70 in order to be rinsed.

FIGS. 6i and 6j show the two switching means 60b, 82a in a second switch position. The combination of the second switch position of the switching means 60b to the second switch position of the switching means 82a leads to now the chromatography column 80 being connected and thus activated to execute the field flux fractioning, while the hollow fiber 20 and the flat channel 50 not being activated to execute the field flux fractioning, thus are switched off and unused, however instead connected to now the rinsing device 70 is connected in order to be respectively rinsed.

The switching means 60b, 82a of the sixth embodiment can also be preferably embodied as rotary switches, operated manually and/or motorized, as schematically shown in FIGS. 6a to 6j.

Alternatively it is also possible to combine the two switching means 60b, 82a to a common switching means, which however is not shown in the attached figures.

Due to the fact that additional structural details and components of the sixth embodiment are consistent with the fifth embodiment according to FIGS. 5a to 5j, to the extent relating to the operation with the hollow fiber 20, the flat channel 50, and the chromatography column 80, as well as the fourth embodiment according to FIGS. 4a to 4h, to the extent relating to the rinsing device 70, and considering that identical reference characters are used for the same components reference is made to the previous description of the fourth and fifth embodiment respectively. With regards to the illustration of the different operating states the FIGS. 6a to 6j also show the same sequence and allocation as FIGS. 5a to 5j.

1. A device for field flux fractioning, with
a sensor for determining the presence of particles in a carrier liquid,
at least one essentially closed oblong channel, which comprises a first end with a first connection and a second end with a second connection and its wall comprises at least one section extending in the longitudinal direction of the channel, impermeable for the particles but permeable for the carrier liquid,
a pump, which comprises an inlet and an outlet and is provided to convey the carrier liquid,
a first liquid path, which connects the outlet of the pump to a first connection of the channel,
a second liquid path, which connects the second connection of the channel to a first switching means, through which the second liquid path can be connected in a first switch position to the outlet of the pump and in a second switch position to the sensor,
an injection device, which is arranged in the first liquid path and provided to inject a sample comprising particles into the carrier liquid flowing through the first liquid path, and
a flow volume—distribution device, which divides the flow volume conveyed by the pump in a first switch position of the first switching means at a predetermined distribution ratio to the first liquid path and the second liquid path and comprises a first flow volume—control device, which is arranged in the first liquid path and is provided for the control of the flow volume of the carrier liquid in the first liquid path and comprises a first valve to adjust the flow volume of the carrier liquid in the first liquid path, wherein
the first flow volume—control device comprises a first measuring device to measure the flow volume of the carrier liquid,
the valve is arranged upstream in reference to this first measuring device and is provided for controlling the flow volume of the carrier liquid in the first liquid path in consideration of the measurements of the first measuring device, and
the pump is provided to convey the carrier liquid in a flow volume that can be precisely dosed.

2. A device according to claim 1, in which a control unit is provided for the controlled conveyance of the carrier liquid through the pump.

3. A device according to claim 2, in which the control unit forms a structural unit with the pump or is integrated in the pump.

4. A device according to claim 1, in which the first valve is a needle valve.

5. A device according to claim 1, in which the flow volume—distribution device comprises a control device, which depending on the measurement of the first measuring device as well as further depending on the input of a target value (X) stating the desired distribution ratio controls the first valve accordingly.

6. A device according to claim 5, in which a second measuring device is provided to measure the flow volume of the carrier liquid dispensed by the pump at its outlet and the control device also accordingly controls the first valve depending on the measurement of the second measuring device.

7. A device according to claim 1, in which the injection device is arranged downstream in reference to the first flow volume—control device.

8. A device according to claim 1, comprising a second switching means by which optionally the injection device can be switched on or off.

9. A device according to claim 1, comprising a third liquid path which is provided to drain carrier liquid discharged from the section of the channel permeable for liquids.

10. A device according to claim 9, in which in the third liquid path a second flow volume—control device is arranged, which is provided to control the flow volume of the carrier liquid in the third liquid path.

11. A device according to claim 10, in which the second flow volume—control device comprises a second valve, preferably a magnetic valve, to adjust the flow volume of the carrier liquid in the third liquid path.

12. A device according to claim 11, in which the second flow volume—control device comprises a third measuring device for measuring the carrier liquid and the second valve is arranged downstream in reference to the measuring device and is provided to control the flow volume of the carrier liquid in the third liquid path in consideration of the measurements of the third measuring device.

13. A device according to claim 1, in which the first switching means is embodied such that it connects in its first switch position the outlet of the pump to both the second liquid path as well as the sensor.

14. A device according to claim 1, in which the channel is embodied as a flat channel with preferably a rectangular cross-section.

15. A device according to claim 1, in which essentially the entire (20c) of the channel is embodied impermeable for particles and permeable for the carrier liquid.

16. A device according to claim 15, in which the channel is embodied as a hollow fiber.

17. A device according to claim 1, in which the channel is embodied in an interchangeable fashion.

18. A device according to claim 1, comprising at least one rinsing device, which can be switched on or off, to rinse at least one unused channel when it is not activated for field flux fractioning.

19. A device according to claim 1, comprising a plurality of channels and a third switching means for an optional activation of a channel from the plurality of channels.

20. A device according to claim 19, in which at least one rinsing device is connected to the third switching means and by which at least one unused channel can be connected.

21. A device according to claim 19, comprising at least one chromatography column and a fourth switching means for optionally activating either a channel or a chromatography column.

22. A device according to claim 21, in which at least one rinsing device is connected to the fourth switching means and by which at least one unused channel and/or at least one unused chromatography column can be connected.

23. A device according to claim 21, with the third switching means and the fourth switching means forming a common switching means.

24. A method for field flux fractioning, comprising:
conveying via a pump a carrier liquid to accept a sample comprising particles through a first liquid path to a first connection of at least one essentially closed oblong channel, which comprises a first end with the first connection and a second end with a second connection and its wall comprises at least one section extending in the longitudinal direction of the channel, impermeable for particles and permeable for carrier liquid, and conveying through the first connection of the channel into the channel,
conveying the carrier liquid using the pump further through a second liquid path to a second connection of the channel and through the second connection of the channel also into the channel, with the overall flow volume conveyed by the pump being divided in a predetermined distribution ratio to the first liquid path and the second liquid path,
injecting a sample comprising particles into the portion of the carrier liquid conveyed through the first liquid path, and
subsequently interrupting the connection between the pump and the second liquid path and thus the conveyance of carrier liquid in the second liquid path and instead connecting the second liquid path to a sensor for determining the presence of particles in the carrier liquid, by carrier liquid comprising particles being conducted from the channel through its second connection and the second liquid path to the sensor,
wherein the flow volume of the carrier liquid dispensed by the pump is adjusted or controlled to a known value and the flow volume of the carrier liquid in the first liquid path is measured and in consideration of a measurement yielded controlled or regulated to a predetermined value.

25. A method according to claim 24, in which the flow volume of the carrier liquid dispensed by the pump is controlled to a certain value.

26. A method according to claim 24, in which the pump dispenses the carrier liquid with a flow volume controlled to a certain value.

27. A method according to claim 24, in which depending on the measurement representing the flow volume of the carrier liquid in the first liquid path and the input of a target value (X) stating the desired distribution ratio the flow volume of the carrier liquid in the first liquid path is respectively regulated.

28. A method according to claim 27, in which the flow volume of the carrier liquid dispensed by the pump is measured and additionally, depending on a measurement yielded therefrom, the flow volume of the carrier liquid is respectively regulated in the first liquid path.

29. A method according to claim 24, in which a sample comprising particles is injected into the first liquid path at a point downstream in reference to the point at which the measurement and/or control and/or regulation is performed.

30. A method according to claim 24, in which carrier liquid discharged from the liquid-permeable section of the channel is guided off through a third liquid path.

31. A method according to claim 30, in which the flow volume of the carrier liquid in the third liquid path is controlled or regulated to a predetermined value.

32. A method according to claim 31, in which the flow volume of the carrier liquid is measured in the third liquid path and in consideration of the measurement yielded therefrom the flow volume of the carrier liquid is controlled or regulated in the third liquid path.

33. A method according to claim 24, in which during the conveyance of carrier liquid in the second liquid path additionally carrier liquid is conveyed from the pump to the sensor.

34. A method according to claim 24, in which a flat channel is used with preferably a rectangular cross-section.

35. A method according to claim 24, in which a channel is used, with its entire wall essentially being embodied impermeable for particles and permeable for the carrier liquid.

36. A method according to claim 35, in which the channel is embodied as a hollow fiber.

37. A method according to claim 24, in which several channels are provided and from this plurality of channels optionally one channel is activated to execute the method.

38. A method according to claim 37, in which the channels are exchangeable.

39. A method according to claim 37, in which at least one channel is rinsed when it is not activated for executing the method.

40. A method according to claim 24, in which in addition to at least one channel at least one chromatography column is provided and either a channel or a chromatography column is activated to execute the method.

41. A method according to claim 40, in which at least one channel and/or at least one chromatography column is rinsed with this at least one channel and/or this at least one chromatography column is not activated to execute the method.
